(19) United States
(12) Patent Application Publication
(10) Pub. No.: US 2016/0083068 A1
(43) Pub. Date: Mar. 24, 2016

(54) High Altitude Balloon

(71) Applicant: Austyn D. Crites, Michigan City, IN (US)

(72) Inventor: Austyn D. Crites, Michigan City, IN (US)

(21) Appl. No.: 14/543,444

(22) Filed: Nov. 17, 2014

Related U.S. Application Data
(60) Provisional application No. 61/905,254, filed on Nov. 17, 2013.
(60) Provisional application No. 61/924,419, filed on Jan. 7, 2014.
(60) Provisional application No. 62/015,288, filed on Jun. 20, 2014.

(51) Int. Cl. B64B 1/40

(52) U.S. Cl. CPC B64B 1/40

(57) ABSTRACT

A high altitude balloon comprised of three parts: a body and two end caps. The high altitude balloon includes a substantially cylindrical body formed with a single rectangular sheet of thin membrane material. The end caps can be made of the same thin membrane material, or they may be made from a different material. The end caps may have a substantially hemispherical (dished) shape or flat (disc) shape, though the end caps may have different shapes. Load restraints may be used on the inside or outside of the balloon body to form a plurality of lobes on the balloon body.

### CROSS-REFERENCES TO RELATED APPLICATIONS

This non-provisional application takes priority to provisional application Ser. No. 61/905,254, filed 17 Nov. 2013, provisional application Ser. No. 61/924,419, filed 7 Jan. 2014, and provisional application Ser. No. 62/015,288, filed 20 Jun. 2014. Wherein all of the above-referenced applications are hereby incorporated by reference in their entirety.

### STATEMENTS AS TO THE RIGHTS TO INVENTIONS MADE UNDER FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISK

Not applicable.

### BACKGROUND OF THE INVENTION

A high altitude balloon refers to manned and unmanned balloons that can be released at ground level and climb into the troposphere, stratosphere, and even the mesosphere. High altitude balloons are filled with a lifting gas or with air maintaining an internal temperature higher than its surrounding atmospheric air temperature, thus generating lift.

Prior high altitude balloons are made up of a large number of gores attached to each other. The term “gore” refers to a tapering sector of a curved surface, such as the typical tapering panels of a hot-air balloon, parachute, beach ball, or plastic film high altitude balloon. A “gored balloon” as used herein refers to a balloon comprised of a body having a plurality of gores attached to each other.

Existing gored balloons are formed by carefully cutting and connecting tens, and up to hundreds, of gores to form the balloon body. The margin for error is very low in the assembly of these gored high altitude balloons. Thus, the assembly of gored balloons requires countless manual labor hours, excessive material handling, specialized equipment, and years of domain expertise to correctly complete.

The membrane or film typically used for high altitude balloons is thin and delicate. In order to float to high altitudes with a minimum balloon surface area and minimum amount of lift gas, only very thin and lightweight materials are suitable for the high altitude balloon membrane. Blimps and aerostats, on the other hand, are made from much thicker and robust materials because of their substantially lower altitude requirements. For example, it is common for the high altitude balloon film to be 0.5 mil thick (0.0127 mm) or less. However, industrial heat sealers usually require a thickness of 2 mil (0.0508 mm) or more of the material being sealed, to safely and securely weld on a consistent basis. This makes most industrial sealers impractical for the thin membranes used for many high altitude balloons, especially if sealed in mass quantities and at high speeds.

Due to the delicate nature of the balloon membrane, the balloon membrane must be treated with extreme care during manufacture to prevent damaging the gores. Most current day balloons are made with thin PE (polyethylene) film that may rip or stretch if overstressed in an industrial packaging and/or continuous sealing operation. The winding and unwinding on roll cores, pulling and twisting, carrier belt grabbing and transport, ambient machine temperature variations, and general abrasion of existing packaging and assembly lines can all cause existing balloon film quality to be compromised if run through continuous industrial systems. The thin membranes used for high altitude balloons are also commonly handled with latex gloves to prevent ripping and tearing of the membrane during manufacture and launch. These factors, among others, have made it difficult to use industrial sealers and automated lines to mass manufacture high altitude balloons.

Because of the above mentioned factors, the mass production of high altitude balloons is not practical with current approaches and state of the art. There is a need for a new type of high altitude balloon and manufacturing method which can be used to produce high quality high altitude balloons at a lower cost and enable their mass production.

### BRIEF DESCRIPTION OF THE INVENTION

Embodiments are directed to a high altitude balloon comprised of three parts: a body and two end caps. An embodiment of the high altitude balloon includes a substantially cylindrical body formed with a single rectangular sheet of thin membrane material. The end caps can be made of the same thin membrane material, or they may be made from a different material. The end caps may have a substantially hemispherical (dished) shape or flat (disc) shape, though the end caps may have different shapes. Load restraints may be used on the inside or outside of the balloon body to form a plurality of lobes on the balloon body.

### BRIEF DESCRIPTION OF THE SEVERAL VIEWS OF THE DRAWING

FIGS. 1A-1C illustrate an embodiment of a high altitude balloon in accordance with an embodiment.

FIG. 2A illustrates a perspective view of a lobed balloon prior to inflation in accordance with an embodiment.

FIG. 2B illustrates a perspective view of an inflated lobed balloon in accordance with an embodiment.

FIGS. 3A-3C illustrate side views of high altitude balloons with different arrangement of restraint lines in accordance with embodiments.

FIGS. 4A-4C illustrate top down views of various end cap embodiments having edges cut so as to form a substantially star-shaped pattern, and with different arrangement of restraint lines.

FIGS. 5A-5D illustrate top down views and a perspective view of circular end cap embodiments, having different arrangement of restraint lines.

FIG. 6 illustrates a perspective view of an embodiment of a wavy mold used for forming lobed balloons in accordance with an embodiment.

FIG. 7 illustrates an end cap draped over a wavy mold to secure the end cap to the cylinder body in accordance with an embodiment.

FIG. 8 illustrates the use of the wavy mold to customize the inside or outside of balloon embodiments in accordance with an embodiment.

FIGS. 9A-9C illustrate the use of a cylindrical mold to seal the second cap of a high altitude balloon in accordance with an embodiment.

FIGS. 10A-10B illustrate an embodiment of a high altitude balloon, where the cylindrical body is formed from rectangular subparts in accordance with an embodiment.

FIGS. 11A-11B illustrate end cap embodiments made from rectangular subparts.

FIG. 12 illustrates a heat seal line assembly for adding a border to balloon film in accordance with an embodiment.

FIG. 13 illustrates an assembly line for adding a circular border to a rectangular balloon film in accordance with an embodiment.

FIG. 14 illustrates a sealing machine for securing end caps to the cylinder body in accordance with an embodiment.

FIGS. 15A-15C illustrate an embodiment of a balloon film with a border material along its edges in order to form a cylindrical high altitude balloon and/or cylindrical high altitude balloon subassembly.

FIGS. 16A-16B illustrate an embodiment of a tetroon high altitude balloon.

FIG. 17A illustrates a cross-sectional view of a wrap seal, and FIGS. 17B and 17C illustrate cross-sectional views of a fin seal in accordance with embodiments.

FIG. 18 illustrates a high altitude balloon panel having a substantially circular shape, having a border sealed along a circumferential edge in accordance with embodiments.

FIG. 19 illustrates a high altitude balloon panel having a substantially hourglass shape, having a border sealed along an edge in accordance with embodiments.

FIG. 20A illustrates an embodiment of a substantially inflated spherical high altitude balloon, formed from two flat circular panels.

FIG. 20B illustrates an embodiment of a substantially inflated lobed high altitude balloon, formed from two flat circular panels with the addition of restraint lines.

FIG. 21 illustrates an embodiment whereby a first panel with a male zipper bordering is attached to a second panel with a female zipper bordering to form a high altitude balloon.

FIG. 22 illustrates a cross sectional view of the mating of two high altitude balloon panels using male and female zipper profile borders in accordance with embodiments.

FIG. 23 illustrates examples of different zipper closure technology that may be used to create mechanical and hermetic seal joints in accordance with embodiments.

FIG. 24 illustrates an embodiment of a substantially spherical high altitude balloon formed from two flat panels, whereby two panels may be attached to one other by attaching the wide section of the first panel to the narrow section of the second panel.

FIG. 25 illustrates a flowchart for building a substantially cylindrical shaped high altitude balloon in accordance with embodiments.

FIG. 26 illustrates a flowchart for building a variety of differently shaped high altitude balloons by bordering the balloon film in accordance with embodiments.

FIG. 27 illustrates a flowchart to create a substantially cylindrical shaped high altitude balloon by bonding first and second bordered end-cap sub-assemblies to the first and second bordered open ends of a cylinder subassembly in accordance with embodiments.

FIG. 28 illustrates a flowchart to create a high altitude balloon from two bordered panels bonded to one another in accordance with embodiments.

FIG. 29 illustrates a flowchart to create a high altitude balloon from two panels bordered with one or more zipper borders to mechanically and hermetically close the balloon in accordance with embodiments.

### DETAILED DESCRIPTION OF THE INVENTION

Embodiments are directed to a high altitude balloon comprised of three parts: a body and two end caps. An embodiment of the high altitude balloon includes a substantially cylindrical body formed with a single rectangular sheet of thin membrane material. The end caps can be made of the same thin membrane material, or they may be made from a different material. The end caps may have a substantially hemispherical (dished) shape or flat (disc) shape, though the end caps may have different shapes. Load restraints may be used on the inside or outside of the balloon body to form a plurality of lobes on the balloon body.

Embodiments of the high altitude balloons described herein consist of three pieces: a cylindrical body, a first end cap, and a second end cap. This is in contrast to prior high altitude balloons comprised of a body having a plurality of gores attached to each other. As noted above, the term “gore” refers to a tapering sector of a curved surface, such as the tapering panels of a hot-air balloon, parachute, beach ball, or plastic film high altitude balloon. A “gored balloon” as used herein refers to a balloon comprised of a body having a plurality of gores attached to each other.

Balloon embodiments described herein are assembled without using full-extending gores, and can be largely mass manufactured with robotics and automation. This provides a great advantage over the present manual labor intensive assembly of gored balloons. In addition, the method of manufacture described herein can be used to add devices, structures, and customize the inside and outside of the balloon body prior to sealing the cylindrical body of the balloon with the end caps. Thus, embodiments provide a launching platform for incalculable advances in high altitude ballooning technology.

Lobed balloons, and specifically pumpkin type super pressure balloons, have been proven to be more pressure resistant in comparison to other spherical or “natural-shape” balloons having no bulge at the gore. Embodiments achieve a lobed balloon without gores by using restraint lines that help the balloon maintain a lobed shape as it inflates.

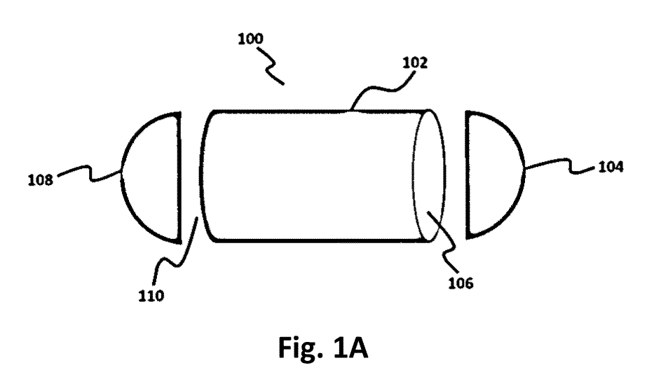

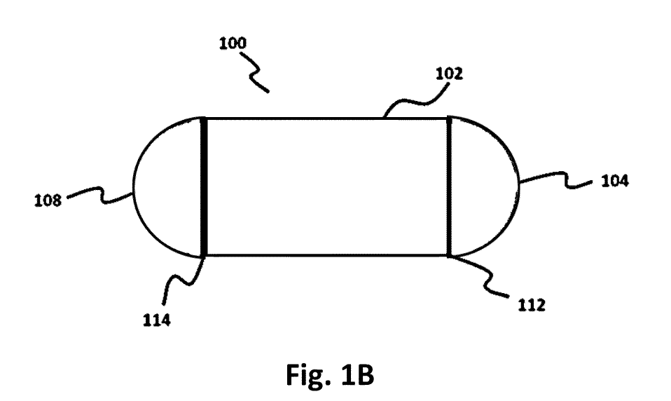

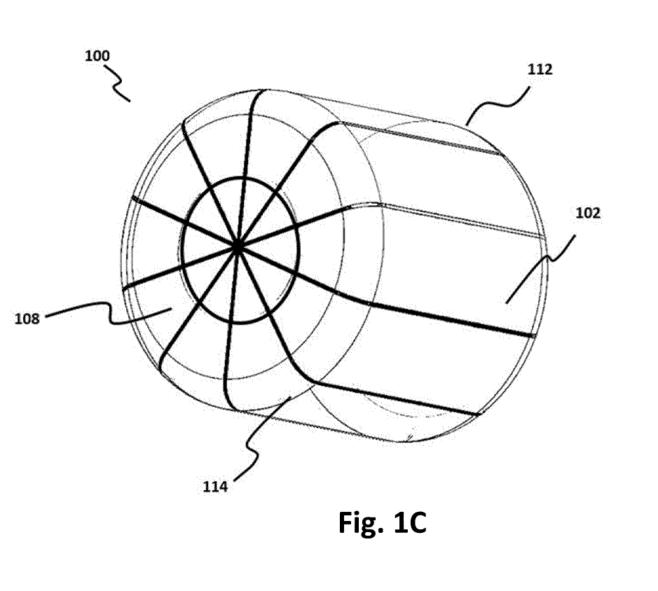

FIG. 1 illustrates an embodiment of a high altitude balloon 100. FIG. 1A illustrates a cylindrical body 102, formed from a single rectangular film sheet folded into a cylindrical shape, rather than being formed from a plurality of gores. A first end cap 104 is attached to a first open end 106 of the cylindrical body 102, and a second end cap 108 is attached to a second open end 110 of the cylindrical body 102.

The end caps 104, 108 are attached to the cylindrical body 102 as illustrated in FIG. 1B. The cylindrical body includes a first circumferential edge 106 and a second circumferential edge 110. The first end cap 104 is attached to the cylindrical body 102 along the first circumferential edge 106, forming a first seam 112. Similarly, the second end cap 108 is attached to the second circumferential edge 110 of the cylindrical body 102, forming a second seam 114. The first end cap 104 and second end cap 108 are substantially dished shaped (also referred to as domed shaped or hemispherical). However, in alternative embodiments the end caps 104, 108 may be flat discs, conical, square, triangular, etc. The end caps 104 and 108 may be formed from the same material as the cylindrical body 102, or from an entirely different material. FIG. 1C illustrates a perspective view of the balloon 100 prior to full inflation.

The film used for the balloon, or alternatively the membrane for the balloon, may be a pressure tight membrane which can stand up to a high pressure differential generated in accordance with balloon altitude and lift gas temperature increases. The membrane of the balloon may also be a low pressure or non-pressure containing (zero pressure) membrane which allows excess gas to escape when the envelope becomes pressurized beyond a predetermined level. The membrane may be made from polyethylene, polyester (MYLAR), nylon, polypropylene, polyurethane, single and multi-layer co-extruded films, rubber, graphene, tightly knit and/or bonded fibers, coated fabrics, or any other suitable high altitude balloon membrane material.

Balloon embodiments may use a combination of load lines and restraint lines in order to form lobes on the body of the balloon. Restraints lines refer to any structure or device used to help maintain the lobed shape, or any other desired shape, as the balloon expands. Restraint lines may be used on the inside or outside of the balloon body. The restraint lines may be applied to the cylindrical body and the end caps. Alternatively, the restraints may be applied only to the cylindrical body, or only to the end caps.

The load restraints may be used to form different types of lobed balloons. For instance, a lobed balloon with a lobed body and lobed end caps; a lobed balloon with a lobed body and end caps without lobes; or a lobed balloon with lobed caps and a cylindrical body without lobes. It is to be understood that load restraints may consist of any combination of devices or structures, including lines, springs, rings, a combination thereof, or any other material used to restrain the shape of the balloon so as to form lobes in the balloon body and/or end caps.

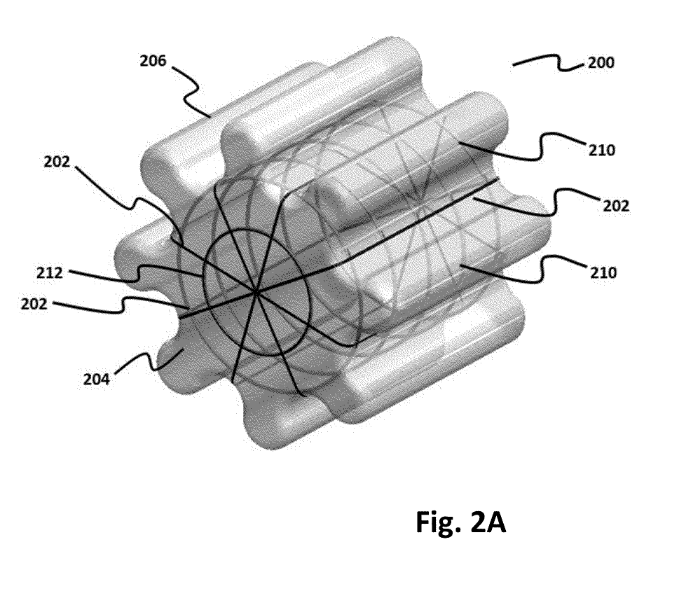

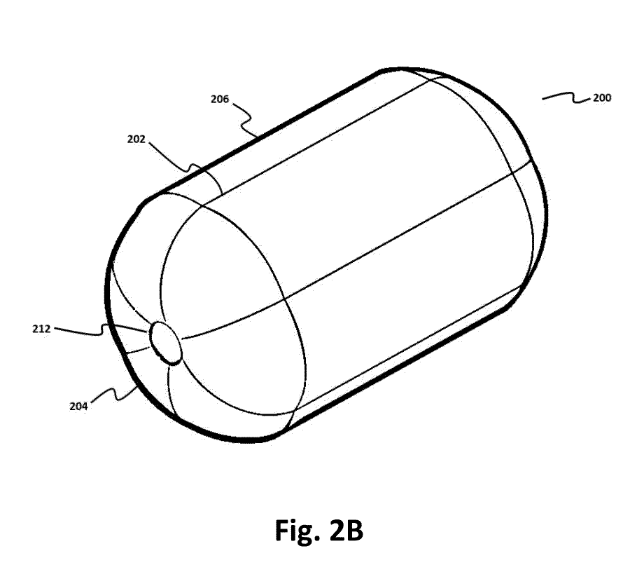

FIG. 2A illustrates a perspective view of a high altitude balloon 200 prior to inflation in accordance with an embodiment. The balloon 200 includes load lines 202 converging on a center of the dished end cap 204. The load lines run along the length of the cylindrical body 206, converging on a center of the second dished end cap (or alternatively the first end cap). The load lines 202 can be gathered at the center of the second end cap to carry a payload. Load lines as used herein refer to lines on the inside or outside of the balloon body which are used to help carry a payload.

In one embodiment, the load lines may be shorter than a total length of the balloon. The load lines, by being shorter than the length of the balloon, uniformly shorten and gather the membrane of the balloon in a longitudinal direction, resulting in many wrinkles (or bulges) forming in a horizontal direction (a lateral direction) on the surface of the membrane.

In yet another embodiment, the load lines may have a length equal to or greater than the length of the balloon. Regardless of the length of the load lines, the load lines may be made from any high-strength material. For example, materials that may be used for the load lines include polyester twine, polyester film strips, synthetic fiber, a KEVLAR line, spider silk thread, carbon nanotube thread, graphene strips, among other materials.

The load lines may be designed to stretch or not stretch. In case that the load lines are designed to stretch, the elasticity may be designed specifically for different types of balloons. If the load lines stretch, they can help absorb different types of pressure differentials and/or violent pressure shocks. Load lines that allow for violent and quick impact softening can stand up well to harsh wind gusts and sharp changes in wind directions, yet may halt stretching altogether once reaching a particular stretch limit. The arrangement of the load lines, the number of load lines, the spacing between the load lines, and the load line material may all be varied and configured depending upon the payload weight, the membrane material of the balloon, the desired altitude, the pressure resistance required, and the budget for manufacture, among other factors. In one embodiment, the load lines may consist of lines arranged on the inside of the balloon along the length of the cylindrical body and/or end caps.

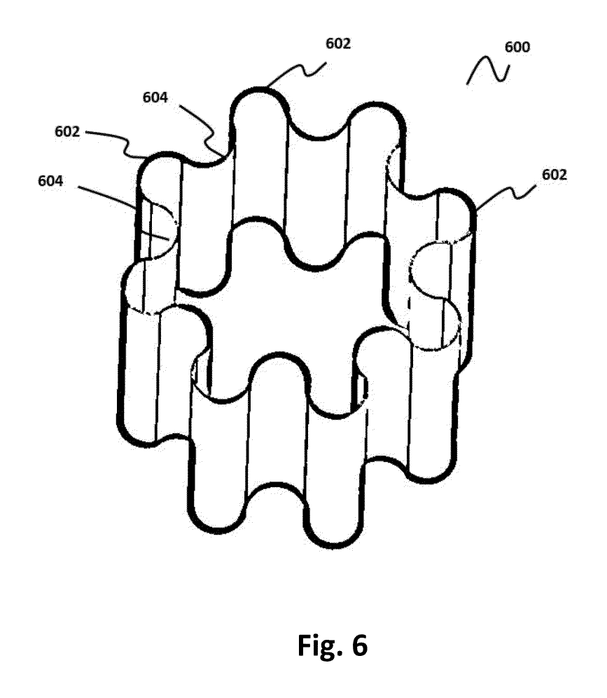

In FIG. 2A, the combination of the load lines 202 and the restraint lines 210 results in a lobed balloon as shown in FIG. 2B. Thus, the lobed shape can be formed without having to use a plurality of gores for the balloon body. The type of lobed balloon described herein may also be referred to as a non-gored variant of the “pumpkin balloon” traditionally made using a plurality of gores. The particular shape illustrated in FIG. 2A may be achieved with restraint lines and load lines, and/or with the wavy mold discussed in reference to FIG. 6.

The balloon 200 includes inner restraint lines 210 arranged along the longitudinal axis of the balloon and along the circumference of the balloon. The balloon further includes a circular restraint line 212 to reinforce the load lines 202 and results in forming lobes on the end caps. The circular restraint line 212 is optional, and a ring or some other device may be used instead.

The inner restraint lines may be attached to the inner surface of the balloon. When the balloon expands, the inner restraint lines restrict the expanding shape of the balloon, forming lobes on the balloon. These inner restraint lines may be arranged substantially parallel to the longitudinal axis of the balloon, substantially parallel to the lateral axis (perpendicular to the longitudinal axis), in a crossing pattern by running one or more load restraint lines along the length of the balloon (longitudinal axis) and running one or more load lines along the circumference of the balloon, along the circumference of the balloon, or any combination thereof. While the restraint lines and load lines are described as being arranged substantially parallel to one or more axis of the balloon, the restraint lines and load lines may alternatively be arranged non-uniformly or in a nonlinear fashion to form lobes on the balloon.

As further described herein, embodiments of the manufacturing method enable the customization and addition of restraint lines or devices to the inside of the balloon in order to form a lobed balloon without the need for gores. The restraint lines may also be arranged on the outside of the balloon similarly to the inner restraint lines. Thus, the lobes may be formed by using only outer restraint lines, only inner restraint lines, or a combination of inner and outer restraint lines.

Restraint lines, or other restraining devices, can be used to form lobes of various sizes and shapes, and also to vary the number of lobes. However, the restraint lines can be arranged differently in order to form rectangular, polygonal, or even circular lobes on the end caps. The size and number of bulges can thus be tuned by increasing or decreasing the number of load restraint lines, the angle of orientation of the load restraint lines, by varying the spacing between the load restraint lines, etc. Different restraint devices can also be used to yield differently shaped and sized lobes on the balloon body and/or end caps. For instance, the end caps may use restraint lines to form the lobes on the end caps, while the body of the balloon may use rings to form the lobes on the balloon body. Thus, restraint devices can be combined and used in different parts of the balloon to customize the lobes of the balloon.

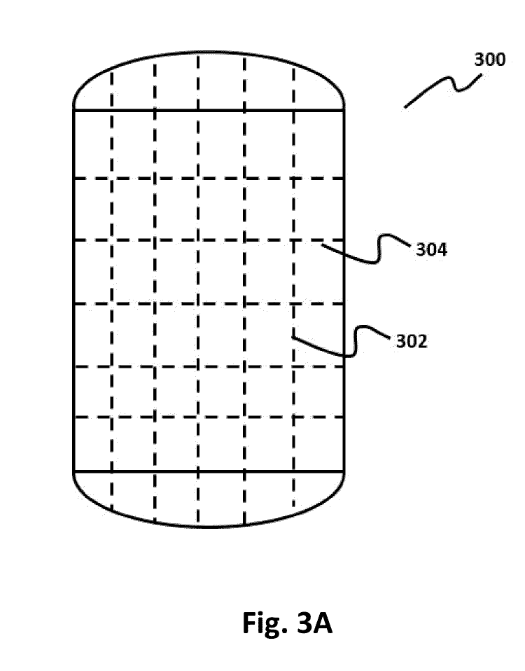

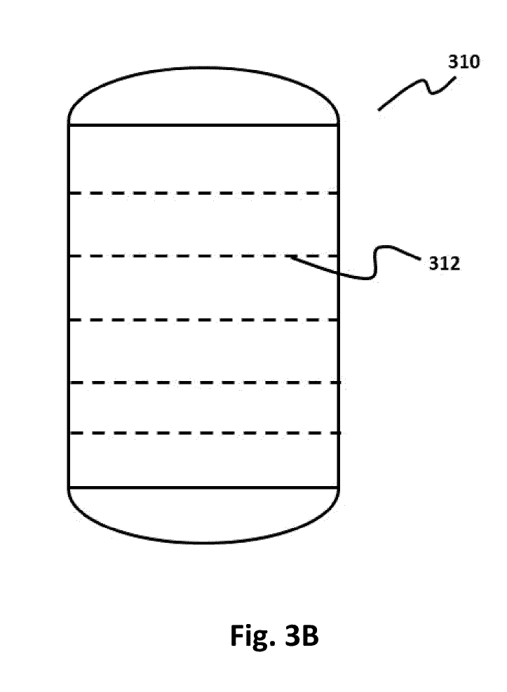

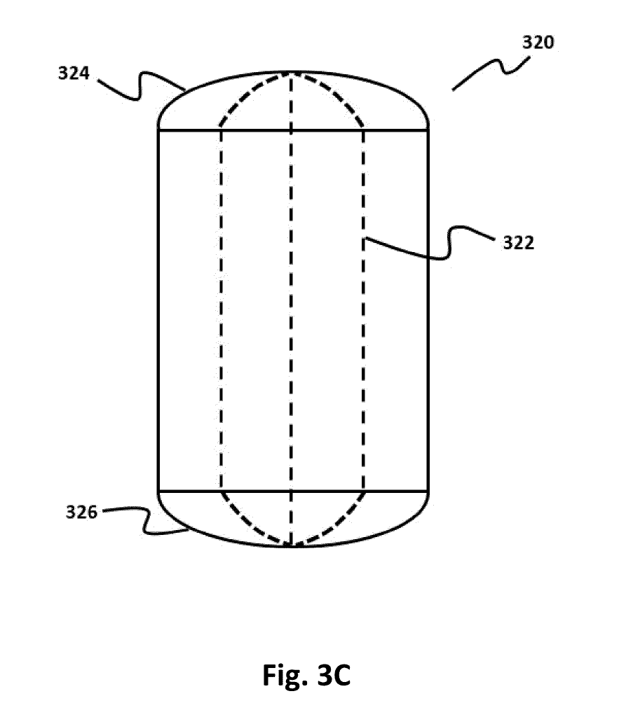

FIG. 3A illustrates a side view of a balloon 300, with the inner restraint lines (represented by dotted lines) arranged along both the longitudinal axis (restraint lines 302) and the circumference of the balloon (restraint lines 304). FIG. 3B illustrates a side view of a balloon 310 with the inner restraint lines 312 laid along the inner circumference of the cylindrical body. FIG. 3C illustrates a balloon 320 with restraint lines 322 which run along the length of the balloon 320 and which converge on the center of the end caps 324 and 326.

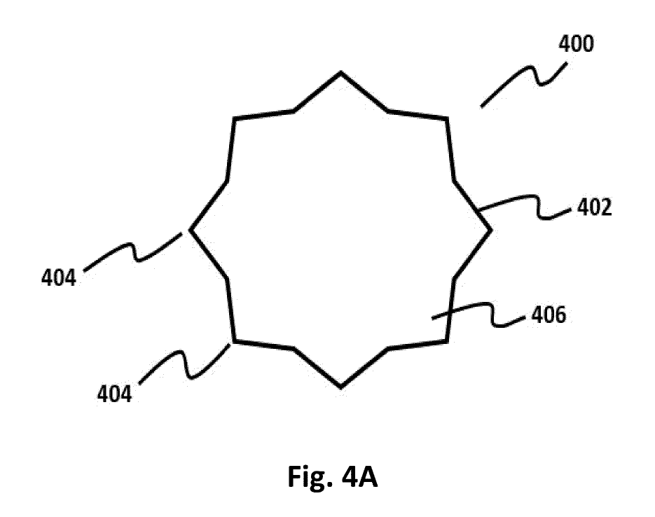

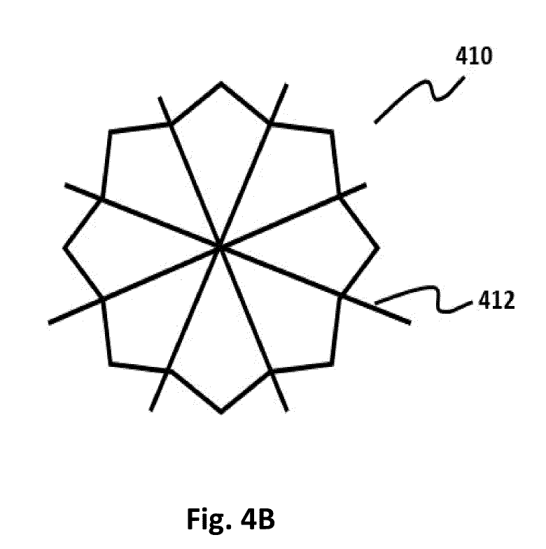

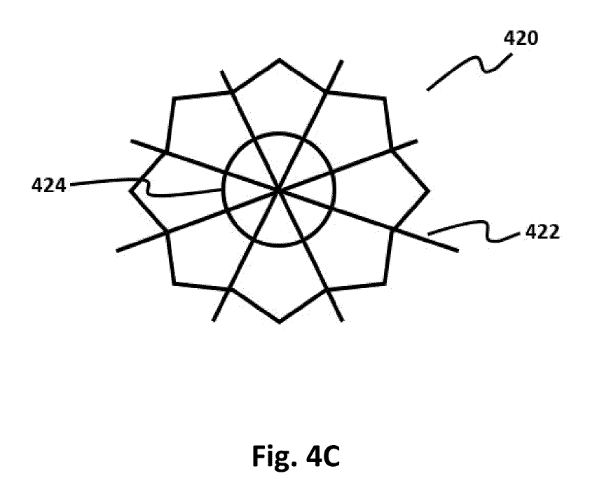

FIG. 4A illustrates a top down view of the inner surface of end cap 400 prior to attaching the end cap to the cylindrical body of a high altitude balloon. The end cap 400 becomes substantially dome shaped after finished assembling, yet the edge of the initial end cap film has been cut so as to form a substantially star shaped edge 402. The end cap edge 402 forms 8 high points (peaks) 404, with each of these 8 points 404 associated with a substantially triangular shaped segment 406. As described in further detail below, the end cap edge 402 is cut as illustrated in FIG. 4A in order to remove excess material before the process of securing the end cap 400 to the cylindrical body. FIG. 4B illustrates end cap 410, but with 8 inner restraint lines 412 which converge in the center of the end cap. FIG. 4C illustrates yet another end cap 420 with 8 inner restraint lines 422, and with an optional circular restraint line 424 surrounding the center of the end cap in order to reinforce the inner restraint lines 422. In FIG. 4C, an alternative device may be used in place of the circular restraint line 424, such as a ring or some other device, to reinforce the inner restraint lines 422.

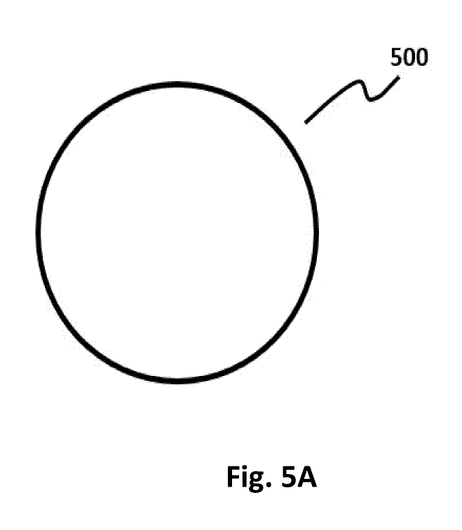

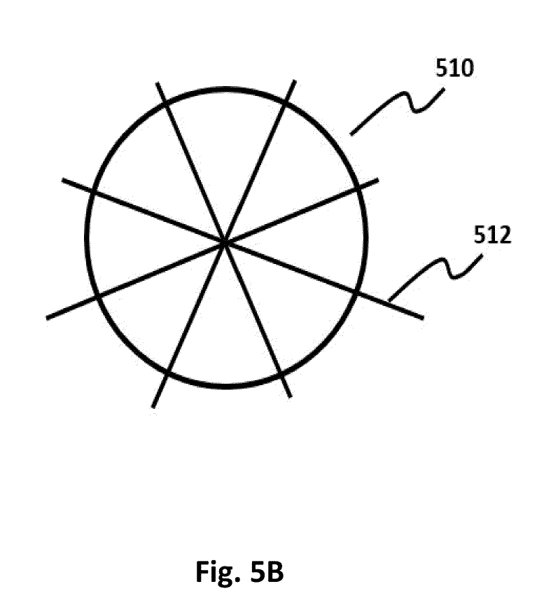

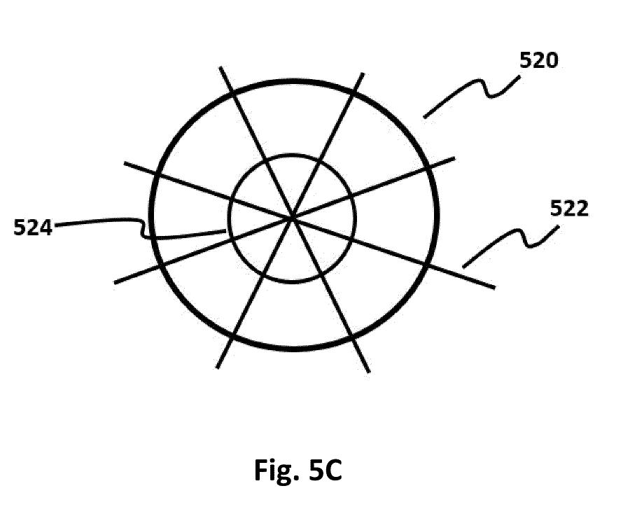

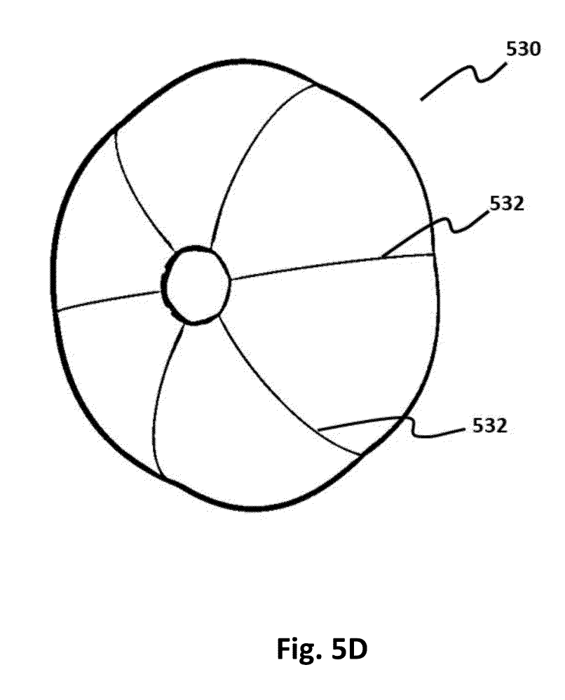

FIGS. 5A-5C illustrate circular end caps, which are sealed to the cylinder body without cutting the edge in a particular pattern. FIG. 5A illustrates a circular end cap 500 which can be sealed to the cylinder body. FIG. 5B illustrates an end cap 510, with inner restraint lines 512. FIG. 5C illustrates endcap 520 with inner restraint lines 522, and circular restraint line 524 that reinforces the inner restraint lines 522. Finally, FIG. 5D illustrates a perspective view of a lobed end cap 530 having restraint lines 532. While FIG. 5 illustrates the use of inner restraint lines, outer restraint lines may also be used.

In one embodiment, the load lines on the exterior of the balloon may be used for both holding the payload, and for restricting the shape of the balloon so as to form lobes. In the manufacture of end caps, the restraint lines or load lines may be mounted on a flat film membrane before cutting the resulting end cap. However, it is also possible to secure the load lines and/or restraint lines after cutting the end cap as illustrated in FIG. 4.

In further reference to FIG. 4, the cutting of the end cap removes excess material that would have to be folded over on itself, either when pre-fabricating the end cap or when attaching the end cap directly to the cylindrical body. Removing this material reduces excess film, and consequently reduces the overall weight of the balloon. In addition, initial end cap film need not be cut to form 8 triangular sections as done for end caps 400, 410, and 420. The end caps may be cut to form any number of triangular sections so as to remove excess material that would otherwise have to be folded while attaching the end cap to the cylindrical body. Finally, the end cap may be cut so as to form differently shaped sections, and need not be triangular. As noted above, in alternative embodiments the end cap shape may be circular, ellipsoid, rectangular, triangular or some other polygonal shape. The end cap manufacture may even skip cutting and folding steps by being thermoformed over or injected in between appropriately shaped molds.

Yet another embodiment is directed to the method of manufacturing a high altitude balloon consisting of a cylindrical body and two end caps. In one embodiment, the cylindrical body of the balloon may be first formed by cutting a plastic sheet and folding the plastic sheet into a cylinder. If a cylindrical film is already available (as per a tubular blown extruded plastic film for example), then the forming of the cylindrical body from a rectangular sheet, or other shaped sheets, may be skipped. The cylindrical film is then draped around a cylindrical mold. The first end cap is placed over one end of the cylindrical film and the cylindrical mold. The first end cap is attached to the cylindrical film. The cylindrical film and first end cap (attached to each other at this point) are slipped off the outside of the cylindrical mold, and they are inserted into the cylindrical mold. If the mold has a closed end and an open end, the first end cap is inserted first into the mold, leaving the open end of the cylindrical film adjacent to the rim of the open end of the mold. The open end of the cylindrical film is pulled out of the cylindrical mold allowing for a portion of the cylindrical film to be folded down over the rim of the mold, exposing the inner side of the cylindrical film. The folding down of the cylindrical film over the rim of the mold is analogous to folding down a bag over the rim of a garbage can.

After folding down a portion (of the open end) of the cylindrical film over the rim of the mold, an insulating band or material can be applied to the portion of the cylindrical film folded down over the rim of the mold (i.e., the exposed inner surface of the cylindrical film folded over the rim). The exposed inner surface is then folded up onto itself, such that the outer surface of the cylindrical film is exposed, and the insulating band (i.e. non heat sealable or heat seal resistant band) is under the exposed outer surface of the cylindrical film. That is, the insulating band is sandwiched between the folded down portion of the cylindrical film and the folded up portion of the cylindrical film. The second end cap is placed over the exposed outer surface of the cylindrical film (the folded up portion of the cylindrical film), and the second cap is attached to the cylindrical film. The finished balloon may then be withdrawn from the mold.

An alternative method for attaching the first end cap or the second end cap may take advantage of existing flat-run ultrasonic welding, RF welding, laser plastic welding, hot air welding, and continuous band heat seal machines for efficient production. In this method, the end caps can be sealed on a continuous in-line machine. In this method, the cylindrical film is folded down over the rim of the mold (as described above), and an insulating band is applied to the folded down portion of the cylindrical film. That is, the insulating band is applied to the exposed inner surface of the cylindrical film near the rim of the mold. As noted above, the insulating band keeps the inner surface of the cylindrical film from welding or adhering to the additional layers that are formed by folding the cylindrical film in the process of sealing the second end cap to the cylindrical body.

In the present method, the folded down portion of the cylindrical film is folded up onto itself, sandwiching the insulating band between the folded down portion and the folded up portion of the cylindrical film. The second end cap is placed over the folded up portion of the cylindrical film (i.e. the exposed outer surface of the cylindrical film). At this point, the second end cap may be secured in place with clamps or adhesive tape, with the insulating band underneath the exposed outer surface. After this step, the first end cap and the cylindrical body are temporarily secured to the second end cap with the adhesive tape, clamps, or some other device. The first end cap, cylindrical body, and (temporarily secured) second end cap are slipped off the mold. The first end cap and cylindrical body are tucked inside the second end cap. That is, the first end cap and cylindrical body are folded or pushed inside the volume of the second end cap. This folding step leaves a depressed hemispherical shape with a protruding circular edge. This protruding edge can then be sealed continuously on a variety of heat seal machines. Only one layer of the cylindrical film will weld to the second end cap layer, with the insulating band(s) keeping the protected film layers from bonding to the layers being sealed together. A continuous band heat sealer, among other machines such as laser plastic welders and hot air welders may also be used for such in-line sealing of the circular edge. For continuous band heat sealing, the process may be easier to complete if only one side of the duel sided heating elements is used. While this sealing method is described for the second end cap, the same method may be used for sealing the first end cap.

FIG. 6 illustrates a wavy mold 600. The wavy mold 600 is substantially cylindrical shaped, while also having an undulating surface. The wavy surface of the mold 600 results in crests 602 and troughs 604. The number of crests and troughs, as well as the respective size of the crests and troughs, can be varied in order to create differently shaped balloons.

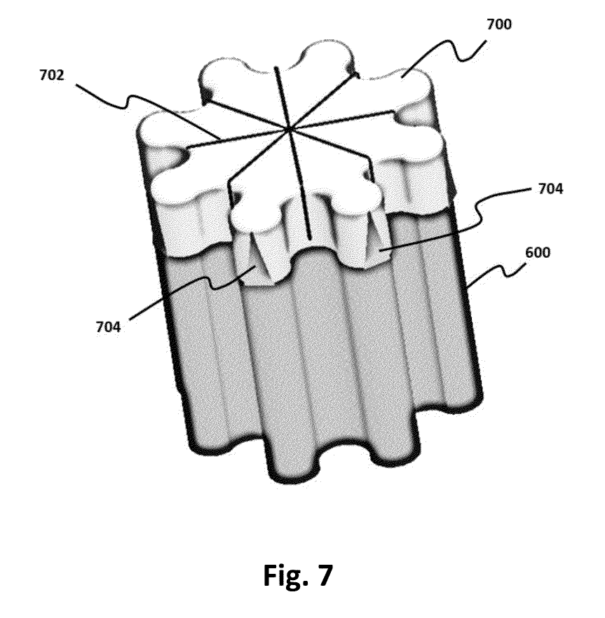

FIG. 7 illustrates an end cap 700 draped over the end of wavy mold 600. Draping a balloon film over the wavy mold 600 allows the balloon film of end cap 700 to assume an undulating shape as well, with this undulating shape forming the basis for the lobes, and resulting in a lobed balloon as balloon 200 from FIG. 2A. End cap 700 further includes load lines 702 which converge on the center of the end cap 700. In yet another embodiment, the mold may have a different shape to form differently shaped lobes on the balloon body. As noted above, restraint lines may also be used to ensure that the cylindrical shaped balloon retains a lobed surface when the balloon is inflated.

End cap 700 includes triangles 704, denoting areas that may be folded over or cut off to allow a tight fit over the mold 600 without excessive wrinkling or uneven bunching of the balloon film. For instance, removing excess material may result in an end cap as illustrated in FIG. 4. This technique achieves the same general shape that a gore can achieve, yet it can be produced from a single flat film which creates no potential gas leak path like gore seams do. These small triangles 704, or folded over film taking any other shape, may then be secured into place by introducing adhesive, adhesive tapes, hot air and hot band welding techniques, laser welding, RF and ultrasonic welding, and/or other securing techniques. The end caps do not need to be directly fabricated over the mold holding the cylindrical film body, and can be pre-fabricated on separate cap molds and stored away in its dished shape, or folded and packaged, until needed to cap the cylinder body.

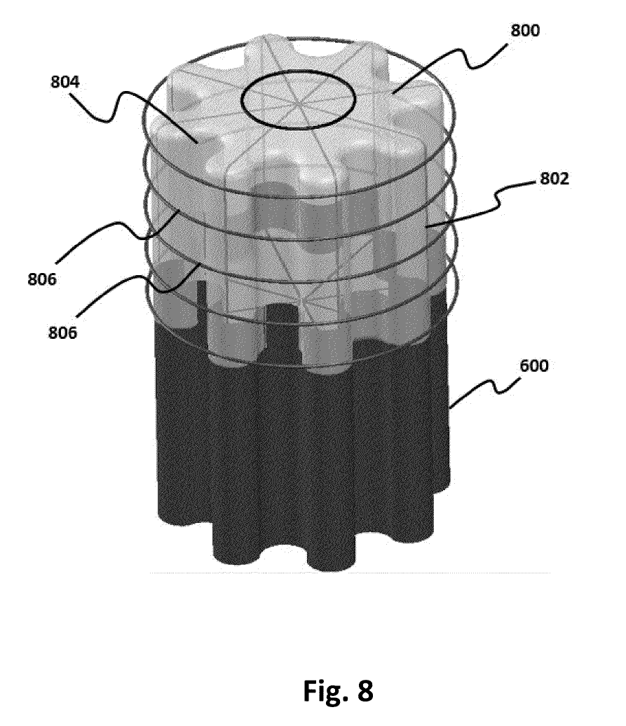

FIG. 8 illustrates how the wavy mold 600 may be used to add structures and customize the inside or outside of the balloon prior to attaching the second end cap. Once the first end cap 800 has been attached to the cylindrical body 802, the resulting body and first end cap (attached to each other) 804 may be turned inside out and draped over the wavy mold 600, to enable the inside of the balloon to be customized prior to adding the second end cap and completely sealing off the balloon body. This can be done, for example, to add restraint lines 806 to the inside of the balloon prior to attaching the second end cap. Another alternative would be to seal the first end cap to the cylindrical balloon body inside out, attach the internal restraint lines, and then turn the balloon right side out before attaching the second end cap. While FIG. 8 illustrates the use of the wavy mold 600, any other cylindrical mold may be used to secure the partially finished balloon 804 while the inner or outer surface of the balloon 804 is being customized.

The restraints lines and load lines may be attached to the cylindrical film and end caps using various methods. The following methods are described for illustrative purposes. However, it is to be understood that any method for attaching the load lines and load restraint lines to the balloon membrane may be used without departing from the spirit of embodiments.

In one embodiment, the load lines may slide up and down the length of the balloon film as the balloon pressures fluctuate and the balloon volume changes.

In yet another embodiment, the load lines and/or restraint lines may be sandwiched between two tape layers. Alternatively, a channeled load tape may be ultrasonic welded, heat sealed or glued to the balloon film. The load line and/or restraint lines may then be fed through the channel. The load lines and/or restraint lines may also be pre-manufactured into the channeled load tape before heat sealing.

Anchor points may also be used in embodiments to secure the load lines and/or restraint lines. For instance, the anchor points may be attached to the balloon film, for example by using heat sealable rivets, and then the load lines and/or restraint lines (or other restraint device, such as a spring) may be attached to the anchor points. Additional connectors and fasteners may or may not be used as is necessary. In yet another embodiment, the load lines and/or restraint lines can be pre-assembled as a large mesh and not attached to the balloon. In this case, as the balloon inflates it fills up the mesh “cage” of load lines and/or load restraint lines.

The cylindrical body 802 in FIG. 8 includes restraint lines 806 along the circumference of the cylindrical body 802. As further described below, the inner restraint lines 806, or outer restraint lines in other cases, may be added before the membrane is formed into a cylindrical body, after the cylindrical body has been formed, after the first end cap has been attached, or during any other step prior to attaching the second end cap (as attaching the second end cap seals the balloon and complicates further modifications to the interior of the balloon). However, as further described below, one embodiment of the balloon may include one or more access ports allowing for modification to the interior of the balloon after the second end cap has been sealed.

Outer restraint lines may also be added at any step similar to the inner restraint lines, with the additional option of also being able to add the outer restraint lines after the second end cap has been sealed. The restraint lines may be prefabricated on the balloon film, such that when the film is formed into a cylinder shape, the resulting cylinder body already includes the restraint lines.

Various attachment methods may be used to secure the end caps to the cylindrical film. These methods may include the use of an adhesive, hot wheel, hot air, band or pulse heat sealing, laser plastic welding, RF or ultrasonic welding, heat-activated tape welding, and electronically activated tape, among other methods. In one embodiment, flexible, rigid, or semi-rigid rings may be used for securing the end caps to the cylindrical body.

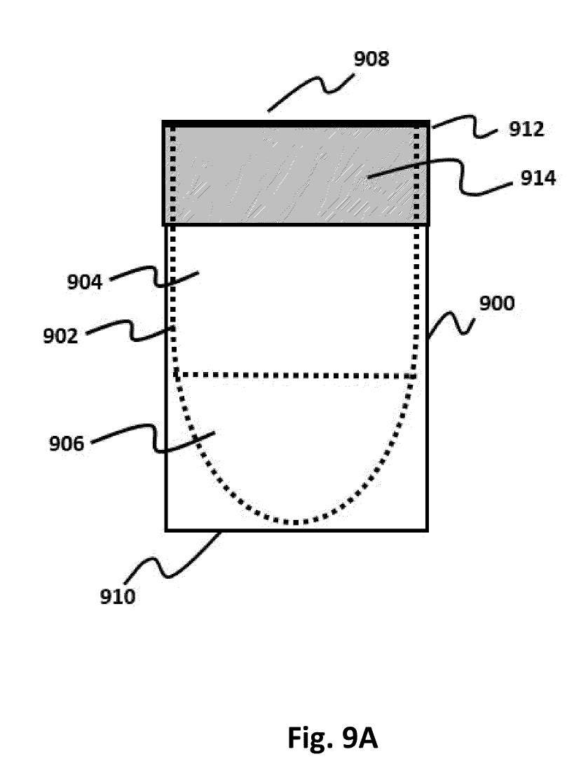

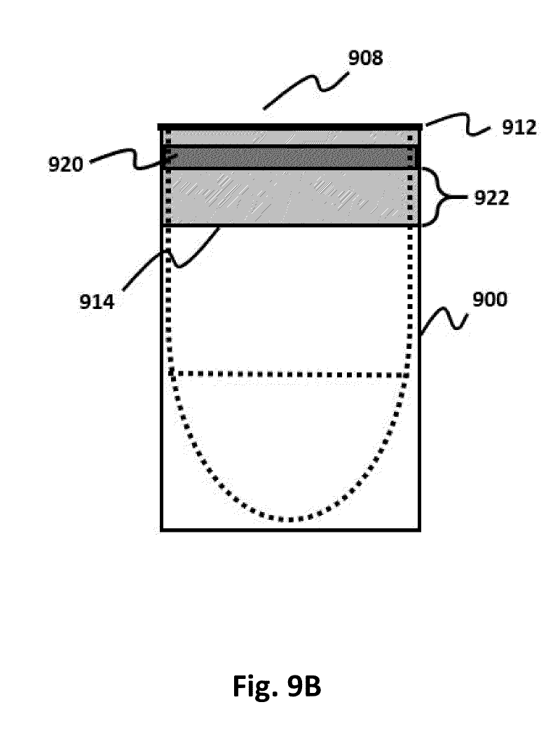

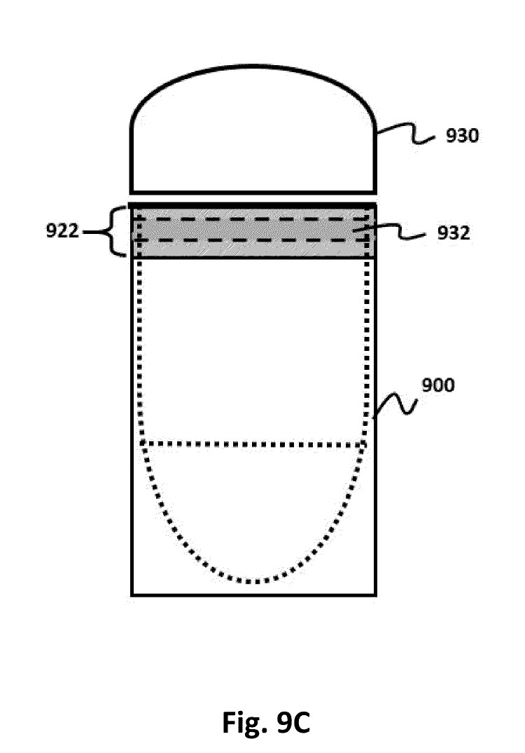

FIG. 9 illustrates the use of a cylindrical mold to seal the second end cap to a cylindrical body already sealed to the first end cap. In particular, FIGS. 9A-9C illustrate a side view of how the edge of the cylindrical body is folded over the rim of the mold so that the second end cap can be attached to the cylindrical body. FIG. 9A illustrates a partially complete balloon 902 inserted into mold 900. The partially complete balloon 902 includes a cylindrical body 904 sealed to a first end cap 906. The mold 900 includes a first end 908 and a second end 910. At least the first end 908 is open so as to enable the sealing of the second end cap. The second end 910 of the mold may be closed or open. The unsealed circumferential edge of the cylindrical body 904 is folded over the rim 912 of the mold 900, exposing the inside surface of the unsealed circumferential edge of the cylindrical body 904. This folded portion 914 on the outside of the mold 900 is shown in gray. A strip of insulating tape 920 is then applied along the folded portion 914 of the cylindrical body 904. The area 922 (denoted by the curly brace), is the area between the tape 920 and the circumferential edge of the folded out portion 914. The area 922 is folded over the insulating tape 920, as illustrated in FIG. 9C. The second end cap 930 is then heat sealed over the dotted area 932 (directly underneath area 932 is the tape 920). In this example, the mold 900 provides a hard backing enabling the second end cap 930 to be pressed and secured against the cylindrical body membrane 904.

In the sealing of the end cap described in reference to FIG. 9, the second end cap 930 will only seal to the exposed outer surface (folded portion 922) because the insulating tape 920 (sandwiched between the folded balloon film) does not allow the layer of film below it to bond to the upper layers. The insulating tape 920 thus keeps the end cap 930 and the cylindrical film sealed together, without damaging or sealing to any other layer of the cylindrical body 904. Such an addition of the insulating tape layer may not be necessary in non-heat transfer attachment methods.

Embodiments described herein may also include the use of structures to absorb fluctuating pressures from within the balloon. For example, an internal resistance spring or internal elastic lines may be used to absorb fluctuating pressures from within the balloon. Elastic lines may include rubber, bungee, plastic strip, spider silk, among others, and combinations of elastic materials either connected to one another or to other inelastic materials. These elastic lines may also be used for the load restraint lines. A balloon may also include a pressure release valve for releasing excess pressure inside the balloon.

Embodiments of the balloon and the method of manufacture enable the creation of high altitude balloons of various configurations. Several examples are described next. In one embodiment, a larger balloon may contain one or more smaller balloons. For example, one small balloon may be inside a large balloon. However, many balloons may also be placed inside the larger balloon. This balloon configuration allows for smaller super pressure balloons (one or more) inside a larger zero pressure balloon. This embodiment allows for various gas cells to be contained within a larger balloon. The inner balloons may have a fixed position, using lines, rings, springs, anchor points, adhesive, or other devices for securing the inner balloons within the larger balloon. Alternatively, the inner balloons may not be attached, allowing the balloons to move within the larger balloon as the larger balloon expands and as pressure fluctuates.

The larger balloon need not be the same shape as the inner balloons. For instance, the larger balloon may have lobes, while the inner balloons may not have lobes. Similarly, the larger balloon may have dished end caps, while the inner balloons may have spherical end caps. The larger balloon may also be made from a different material than the inner balloons. For instance, the larger balloon may require a stronger material that can resist internal balloon pressure fluctuations, while the inner balloons may be made from a thinner and lighter material that is highly impermeable to gas. When using more than one inner balloon, the inner balloons need not be the same shape and size. That is, a first inner balloon may have a first size and shape, while a second inner balloon may have a second size and shape different than the first size and shape. The inner balloons may also differ in material, and each inner balloon may even include a different internal component within each balloon.

In yet another embodiment, a balloon may include internal springs in order to force to balloon to retain a particular shape. One end of the internal springs may be fastened to a ring in the center of the cylindrical body of the balloon. The second end of the internal springs may be fastened to the inner surface of the balloon film. The second end of the internal springs may also be fastened to the inner restraint lines of the balloon, to anchor points on the inside of the balloon, or to one or more rings arranged on the inside of the balloon.

In yet another embodiment, elastic restraint lines may be used on the inside of the balloon, though it is also possible to use elastic restraint lines on the outside of the balloon. The elastic restraint lines may be arranged substantially along the circumference of the cylindrical body, but it is also possible to arrange the elastic restraint lines parallel to the longitudinal axis of the cylindrical body, or arranged linearly along any angle/direction. The elastic restraint lines may also be arranged non-linearly if needed.

In another embodiment, multiple balloons may be connected to each other. For instance, a larger middle balloon may be sandwiched between a smaller left balloon and a smaller right balloon. Thus, a first balloon can be connected to one or more other balloons, with the cylindrical bodies of the balloons arranged like pipe segments, and with the end caps functioning as fittings to the pipe segments. The balloons may have different sizes and shapes, and may also be made from different materials. When using different sizes and shapes, what is important is that the segments where balloons connect fit appropriately and have a secure seam that does not leak gas.

In one embodiment, the cylindrical body of a first balloon may be connected (like hot tapping of pipe segments) to the cylindrical body of a second balloon. Hot tapping refers to the method of making a connection to a pressure vessel without the interruption of emptying that section of vessel. Using this technique the cylindrical body of a first balloon can be fed through the cylindrical body of a second balloon. A plurality of balloons may be hot tapped in various configurations. For example, a set of smaller balloons may be hot tapped to a single larger balloon. Alternatively, the balloons may be hot tapped so as to form pipe like segments completing as complex a structure as needed.

In one embodiment, the PET film can be bordered or fully laminated with a PE film (or other heat sealable membrane) bordering which can then seal to other heat sealable borders. For instance, a traditionally non heat sealable film, such as polyester film, may be used for the balloon film, and a heat sealable substrate may be added to the borders of the balloon film. Heat sealable substrates may include polyethylene, polyurethane, or a plurality of other materials. The balloon film and the heat sealable borders may be prefabricated on continuous rolls. These embodiments are further described in detail below.

The balloons described herein allow for further configurations to the balloon during the balloon assembly. For instance, circuits, sensors, photovoltaic cells, or any other circuitry or device can be added to the balloon prior to sealing the end caps of the balloon. If using plastic film on a roll, the plastic film itself may already include circuits, sensors, or other devices printed or already adhered to the balloon film, such that as the balloon film is unrolled, it already includes the desired elements, and it can be cut to form the cylindrical body and the end caps. Other elements that can be applied to the balloon film includes UV protection coatings and/or UV resistant “scales”.

The goreless flat film design allows the surface of the balloon to be printed and laser guided before and during manufacture. This allows for mass production precision guide markings, such as printer color blocks and position marks, among other markings, to be introduced into the high altitude balloon manufacturing process. This also allows for pre-printing and customization of product advertisement and other adverts. This is in contrast to gored balloons, which make this pre-printing and marking difficult because the printed material may extend across multiple gores, distorting the printed material and making it difficult to precisely cut and match up the respective gores.

In embodiments of the balloon, the balloon has two circumferential seams, in contrast to the dozens or hundreds of seams on prior gored balloons. During manufacture of present embodiments, the seams can be rotated while welding so that many weld rings can be made on each seam (with precision spacing in between) to ensure a near perfect impermeability to gas leakage. It is hard to ensure such precision with hand-made gored balloons as is presently done in the industry. Therefore, present embodiments provide the advantage of being easier to test for leakage on the only two seams of the balloon.

As noted above, embodiments enable the internal components to be added to a balloon during the manufacture of the balloon prior to, but not necessarily prior to, sealing the second end cap. The addition of one or more access ports, for example, can allow further access to the inside of the balloon even after the second end cap has been sealed. For example, a sensor system, an antenna, and a battery may be added to the inside of the balloon prior to sealing the second endcap. It is to be understood that any device, sensor, or circuitry may be added to the inside of the balloon prior to sealing the second end cap.

In one embodiment, an access port may be formed on the balloon to enable access to the interior of the balloon after the second end cap has been added to the balloon. That is, the access port enables access to the inside of the balloon after the balloon has been sealed and completed. One or more access ports may be added to a balloon. A port can be created by reinforcing a particular perimeter on the outer or inner surface of the balloon. The inside of the perimeter may then be removed, such as by cutting. After accessing the inside of the balloon, the access port can be closed by sealing another film over the access port, using sealing techniques described herein.

In one embodiment, a substantially ring shaped sticker can be added to the outside of the balloon. The inside of the ring can be cut out, allowing access to the inside of the balloon. A sealing sheet may then be positioned over the ring, thus sealing the cut out portion and the balloon. The ring shaped sticker may have a peel off self-adhesive backing, which can be peeled off prior to adding the sealing sheet. Alternatively, the sealing sheet may be positioned over the cut off portion and attached to the balloon using an adhesive. The ring shaped sticker may also be added to the inside of the balloon during the manufacture of the balloon. For example, the rolls of the balloon membrane may already include ring shaped stickers, or other types of reinforced points.

While a ring shaped sticker is described in the present example, alternatively shaped stickers or access ports may be used with balloon embodiments. For instance, a portion of the balloon may be reinforced with a rectangular border, or some other polygonal border. The inside of the border may then be cut, allowing access to the inside of the balloon.

The sealing of the first end cap and second end cap to the cylinder body may be performed using various techniques. In one embodiment, the edges of these parts can be sealed together with one or more sealing methods, such as abutting the edges of these parts and sealing the edges together. The edges can be sealed together with a butt weld, such as by running a sealing strip over the abutting edges along the length of the edges. The edges can also include a border, with a sealing strip created over the border of the abutted edges during the sealing process.

The edges including the borders can be sealed to each other with or without an additional layer of material. That is, a first edge with a first border can be sealed to a second edge with a second border, such as by placing the first border over the second border, and running the border through a sealing machine, such as a heat sealer. This is an example of sealing without an additional layer of material. Alternatively, the edges including the borders can be sealed to each other by placing the edges next to each other, placing an additional layer of material over the abutting edges (overlapping the two edges), and then sealing the additional layer of material to the first edge and the second edge. In any butt weld sealing method, an additional layer of material is needed to seal the abutting edges because the edges do not overlap and it is not possible to seal them without the additional layer of material.

When sealing two abutting edges without the borders, the additional layer of material can seal the two layers together by placing the additional layer of material on top, on bottom, or on top and bottom of the abutting edges, and then running the abutting edges with the additional layer or layers of material through a sealing machine. The order of sealing can be varied without departing from the spirit of embodiments. For instance, the additional layer of material can be sealed to the edge of a first subpart. The edge of a second subpart can then be positioned adjacent to the first edge and overlapping with the free portion of the additional layer of material, and then the edge of the second subpart can be sealed.

The term “sealing strip” hereafter refers to the layer of material applied over any area which needs to be sealed. The sealing strip and the material being sealed are run together through a sealing machine. The sealing machine forms a seal over the sealing strip. The term “sealing line” will be used to refer to the seal or seam created between two sealed materials. This sealing line can be of any width and/or length, may be obtained by any type of seal configuration (such as butt seal, fin seal, lap seal, hem and rope seal, plastic zipper strip or other mechanical barrier closure, etc.), and can be created by a myriad of different sealing technologies including but not limited to continuous band sealers, hot wheel sealers, ultrasonic welding, RF welding, impulse welding, laser plastic welding, adhesive bonding, hot bar sealers, among many other sealing possibilities.

One embodiment is directed to a high altitude balloon formed by adding a border to the edges of two or more parts, the two or more parts joined to form the balloon. The border reinforces the edges, and the border of one subpart can be sealed or welded to another subpart by overlapping the borders or abutting the borders of the subparts. That is, rather than sealing together a balloon film edge with another balloon film edge, a border is added to the balloon film edges, and the border of the first edge is joined to the border of the second edge. For example, the borders can be abutted and then sealed together with a sealing strip. This method keeps the balloon film, which is typically delicate and extremely thin, from being damaged during the sealing process. In addition, this method enables the use of other materials, which are not traditionally heat sealable, to be sealed securely and strongly in order to form a hermetically sealed balloon. Sealing and welding will be used interchangeably in this specification. Both sealing and welding can be used as necessary for embodiments described herein.

In one embodiment, the sealing strip is first applied to the edge of a first part. The sealing strip is aligned such that a portion of the sealing strip covers the edge of the first part, while the remaining portion is free for the edge of the second part. The second part can be aligned and abutted against the edge of the first part and over the remaining portion of the sealing strip. The edge of the second part can then be sealed to the remaining portion of the sealing strip. The free portion of the sealing strip can then be sealed to the edge of the second part, thus sealing the first subpart and the second subpart together. In these embodiments, the edges of the first part and the second part need not overlap each other and need not be directly sealed on top of each other. That is, they are indirectly sealed through the sealing strip that overlaps the edges of the first part and second part. By sealing together the first part and the second part with the sealing strip, the structural integrity of the first part and the second part is maintained.

While reference is made to balloons made of subparts, such as a first subpart, a second subpart, etc., it is to be understood that these terms are used for illustrative purposes. In some embodiments, balloons can be made from at least a cylinder body, as the pillow shaped and tetroon balloons described below. The balloon can also include a first end cap, a second end cap. Each of the cylinder body, the first end cap, and the second end cap can optionally be made of subparts.

The border can be added to the edge of any balloon subpart, regardless of the shape of the subpart. For instance, if one subpart is circular, then a circular sealing border can be added to its edge. The border can be circular, or it can be a straight border which is curved slightly along the edge of the circular subpart in order to get the border to cover the circumferential edge of the circular subpart. If a subpart is triangular shaped, then a border can be added to each of the three sides of the triangular subpart. For a rectangular subpart, four borders can be used to cover each of the edges. For any subpart, not all of the edges need a border. While in some cases a border may be necessary on each edge, at other times it may be needed or desirable to leave some edges without a border. The border may or may not extend beyond the edges of the subparts, and may be located anywhere within the subpart itself. It should also be noted that the border may be co-extruded or otherwise co-fabricated along with the balloon subpart itself, and such process would not depart from the spirit of the included embodiments.

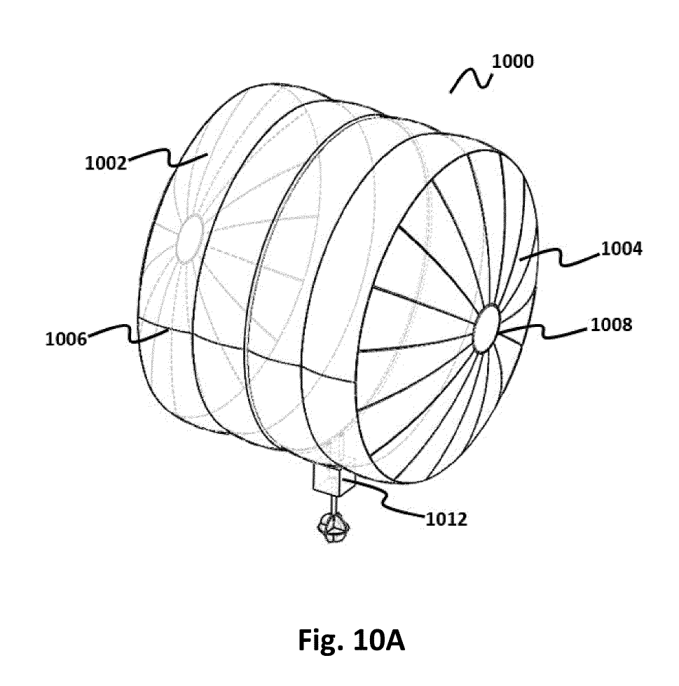

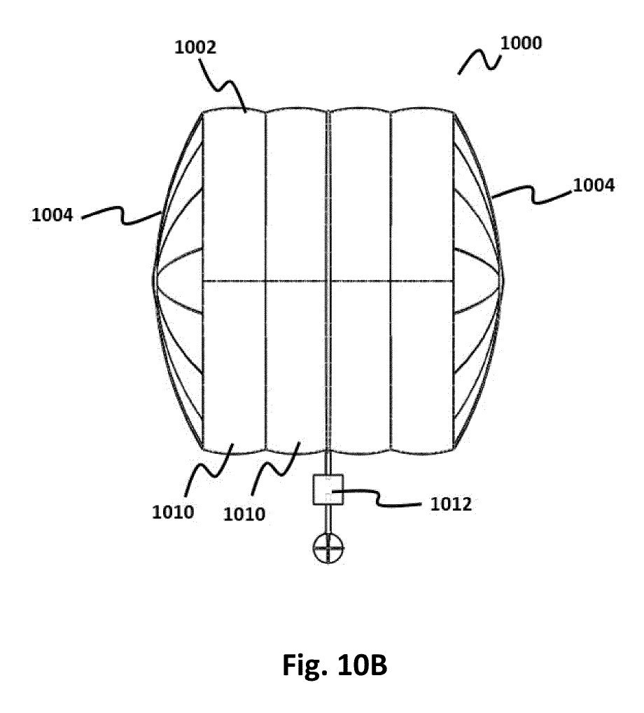

FIG. 10 illustrates an embodiment of a high altitude balloon 1000 in accordance with an embodiment. The balloon 1000 is formed from a cylindrical body 1002 and two end caps 1004. The cylindrical body is formed from four long rectangular subparts. Each rectangular subpart is formed into a circle by joining its two shorter ends. Several of these circles are then joined together to form a cylinder body and resulting in seam 1006. Alternatively, several rectangular subparts may be first joined together into a larger rectangular subpart and then formed into a circle by joining the two shorter ends of the larger rectangular subpart. The end caps are formed by several substantially triangular shaped subparts which are joined together into a circular shape. Alternatively the larger end caps may be formed by joining together several rectangular subparts into one larger rectangular subpart and trimming off the excess material into the required endcap shape, i.e. a circle subpart. A cap center 1008 is sealed over the center of the circular subpart. The cap center (or termination cap) 1008, while optional, reinforces the triangular subparts and facilitate the joining of the narrow edges.

FIG. 10B illustrates a side view of the balloon 1000. The side view shows four rectangular subparts 1010 joined together and then folded into a cylindrical shape in order to form cylinder body 1002. The balloon 1000 includes a payload 1012 hanging from the cylinder body 1002. The payload 1012 may or may not hang from a circumferential load line that spans the seam or seams adjoining the long rectangles that comprise the cylinder body 1002. Many other payload attachment methods are possible such as securing additional vertical and horizontal load lines, spanning a horizontal stiff member such as a carbon fiber pole along the bottom of the balloon to which the payload is attached at the center, attaching to anchor points welded to the balloon film and/or seams, among a myriad of other payload attachment possibilities.

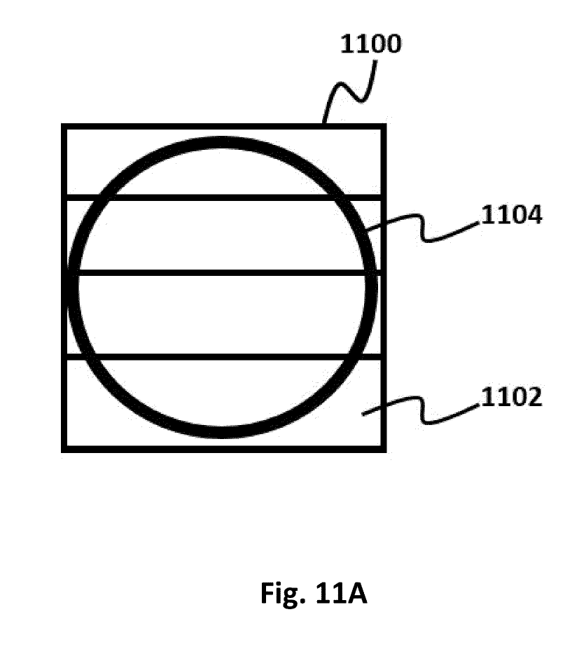

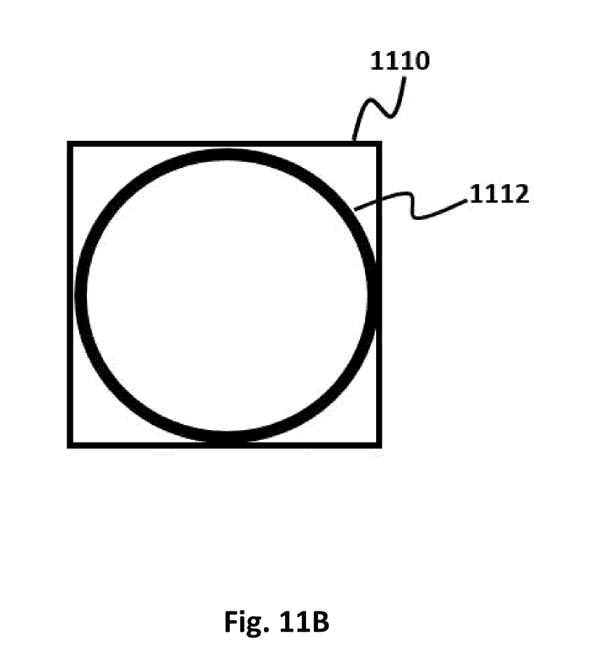

FIG. 11A illustrates an embodiment of an end cap 1100 that is made from rectangular subparts 1102. The rectangular and/or square end cap 1100 can then be sealed to the balloon body along the illustrated circular boundary 1104, or the rectangular end cap 1100 can be sealed to the balloon body by folding the corners of the rectangular end cap or trimming off any excess material. While the end cap 1100 is illustrated as consisting of rectangular subparts 1102, it is also possible to have a single balloon film make up the end cap without any subparts, as illustrated in FIG. 11B. Alternatively, the rectangular and/or square subpart may be trimmed into a circle or any other shape to create a differently shaped end cap. The end cap subparts, rectangular, square, circular, and/or any other shape, may or may not be bordered with a sealing strip before sealing to other balloon subparts. Such a bordered or un-bordered single subpart may comprise an entire balloon envelope itself, as would be the case by forming a tetrahedral or pillow case balloon by joining a rectangular subpart at its two shorter ends to form a cylinder, and then sealing closed the first and second cylinder ends either parallel or perpendicular to one another.

The embodiments of the sealing method described enable the use of high tensile strength materials for high altitude balloons. The sealing method further enables traditionally non heat-sealable materials, such as non-heat sealable plastics, for high altitude balloons. For instance, Nylon and PET film can be used for the balloon membrane. Using high tensile strength materials for the membrane of the balloon results in balloons that can better sustain the weight of a payload and internal pressure, improve abrasion resistance, and not require such a carefully positioning of load ropes as is often needed with thin polyethylene film balloons. Nylon and PET based multi-layer laminate heat-sealable films, or heat sealable co-extruded films, can also be sealed using this sealing method, and offer superior pinhole resistance and gas transmission qualities over bare Nylon and PET film alone.

As noted above, the manufacturing methods described herein provide advantages over present and prior manufacturing techniques of high altitude balloons. First, prior manufacturing techniques of high altitude balloons are inefficient because they require the cutting of large tapered gores. These gores are then laid flat on long tables, requiring slow manual labor to seal the gore edges together. This process is time consuming and labor intensive, rendering the manufacturing cost high while hampering the ability to scale in mass quantities.

When it comes to balloon materials, traditionally non-heat sealable film, such as PET and Nylon, cause great difficulty for attaching gores to each other when made from these materials. However, these materials have several properties that can benefit the mass manufacture of high altitude ballooning in accordance with our embodiments, such as superior tensile strength, ease of running through packaging machines, and general abrasion resistance. These films are robust in many ways, and so there is less risk of damaging the films during manufacture and even during launch of the balloons. The superior tensile strength of these films also keeps them from expanding much under pressure, making them suitable for super pressure balloons without the need for over complex load lines and/or precise balloon envelope shapes. Several other balloon materials are multi-layer films that are co-extrusions or laminations of various types of polymers and other materials.

One embodiment is directed to a mass production method of assembling high altitude balloons. The method can use simple and regular shaped subparts, such as rectangles and circles, rather than having to operate on triangular shaped gores. These shapes can be used to create a high altitude balloon made from a cylinder body and two end caps. However, the method described also has the flexibility to create a balloon of any desired shape and to form balloons from any shaped subparts.

The balloon film can be bordered with a robust perimeter before assembling the balloon subparts. The balloon film and the robust perimeter may also be co-extruded or co-manufactured at the same time the balloon film is processed. This bordering can also be done during the actual assembly of the balloon. The border can be thicker than the balloon film. For example, the balloon film may have a thickness of about 0.5 mil (0.0127 mm), while the border may have a thickness of about 3 mil (0.0762 mm). The size and thickness of the border can depend upon several factors and can be varied as needed. The thicker borders can be run through many high speed sealing machines to obtain fast and consistent bonds. The borders may be single side heat sealable or two side heat sealable, or may be attached to the balloon film by any other means of adhesion, including by mechanical and chemical means. Thus, whereas the thin membranes of high altitude balloons cannot be easily manipulated and sealed by industrial sealing machines, the addition of borders to the thin balloon film, as done in our embodiments, enables the thin membranes to be effectively manipulated and sealed with industrial sealing machines.

Adding borders to the balloon membrane allows for traditionally non-heat sealable films, such as PET and NYLON, to be used as the membrane for high altitude balloons and further enables high altitude balloons to be mass-produced in assembly lines. Heat sealable films, such as PET, may also use such a bordering technique to strengthen the films before and/or during sealing one or more parts together. Different types of materials can be used as the border. For example, a PUL (polyurethane laminated) fabric can be added as a border to a balloon membrane, such as PET film. The PUL borders can then be attached to other PUL borders of other balloon subparts, with the attachment being done with sealing machines. A PET film with the PUL fabric border can be run together through a continuous band sealer, continuous heat bar and compression roller system, an ultrasonic sealer, an RF welder, hot bar sealer, co-extrusion, lamination, among other machines and processes, to make consistent bonds quickly and efficiently. Another example of material combinations would be a more robust PE (polyethylene) border added to a thinner PE balloon membrane. Many material possibilities either currently exist or are being developed, including carbon fiber composites, graphene films, carbon nanotube films, among many other plastics, metals, and composites.

The bordering described above can be accomplished on straight and curved packaging lines. This enables the rolling and unrolling of large quantities of balloon material, with the packaging line occupying minimal space. The border and/or the balloon film/membrane can both be wound on rolls. These rolls can then be controlled with assembly lines. This is in contrast to present industry techniques where a person, and/or machine on a track, must move up and down a sealing table in order to seal gores together.

It has been long believed in the high altitude balloon industry that cylindrically shaped balloons are largely impractical because of the difficulty of terminating the ends of the cylinder body. Different techniques have historically been employed such as “pillow case” pinching end termination and “bunched” end termination, both of which have showed subpar results as they largely distort an efficient cylindrical shape for net gas lift and pressure resistance. Prior techniques for making balloons consist of sealing together several long rectangular strips of material, and then bunching up the ends into termination fittings or simply pinching the ends together into a pillow case shape. This is not efficient from a surface area to volume and pressure resistance standpoint. Consequently, more lift gas is needed for these types of balloons compared to more spherical shaped balloons. In addition, these types of balloons are not typically suitable for efficient long-duration super pressure ballooning.

In contrast, our embodiments include methods for attaching end caps to a cylinder body, without the pinching or the bunching up of the ends of the cylinder. Our methods thus improve a balloon's efficient lift and pressure holding capability. It should be noted that a short “stubby” cylinder balloon with end caps (where the cylinder balloon's height roughly approximates its diameter) will become a near sphere once inflated and under sufficient pressure. End cap embodiments will be described below, including circular end caps with a border for sealing with the border of the cylinder body.

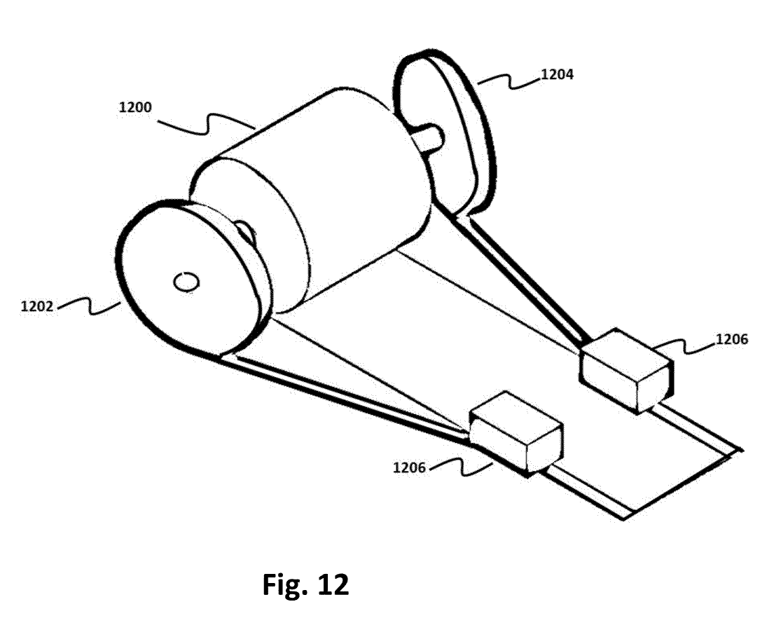

FIG. 12 illustrates a heat seal line assembly for adding a border to balloon film before actual assembling subparts of the balloon into the final balloon shape, in accordance with an embodiment. The assembly line includes a roll of balloon film 1200. The balloon film can be a plurality of materials, including PET, NYLON, PE film, etc. Adding the border to these types of films enables a wider range of materials to be used for high altitude ballooning, while also enabling these materials to be assembled on assembly lines for the mass production of high altitude balloons. Adjacent to the roll of balloon film 1200 are a first roll 1202 and a second roll 1204 of bordering material. The bordering material may be a heavier plastic film, laminated fabric material, such as PUL fabric, or a heat sealable PE laminated fabric or plastic strip. As noted above, the border reinforces the edges of the balloon film to enable edges of balloon subparts to be sealed together into a balloon shape.

As the balloon film 1200 unrolls, the bordering material rolls 1202 and 1204 are also unrolled. Two heat sealing machines 1206 seal the border material to the unrolled balloon film, resulting in the balloon film having the border material sealed along its edges. The balloon film with the sealed border material may be wound into a new spool or cut off at predetermined lengths. Different sealing machines may be used, such as an RF welder, hot wheel sealer, hot air sealer, hot wedge sealer, ultrasonic sealing machine, hot bar sealer, impulse sealer, and continuous band sealers with or without compression rollers, among others.

The arrangement of the assembly line can be varied without departing from the spirit of embodiments. For example, rather than rolling the balloon film with the sealed border into a spool, a cutting machine may slice the balloon film of a certain length. In addition, rather than having two sealers 1206, only one sealer may be used, and more than two sealers may be used, either on the top or on the bottom. If it is necessary to add a border to a non-edge of the balloon, such as along the middle of the balloon film, then another sealer can be positioned such that as the balloon film is unrolled, the border is sealed to the balloon film at the corresponding location. Also, in place of a continuous heat sealer, other sealing devices may be used, such as an RF welder, an ultrasonic sealer, impulse sealer, hot air sealer, hot wedge sealer, adhesive bond, mechanical bond, etc.

Embodiments are not limited to using a heat sealing machine. Any other sealing device may be used to seal the two rolls of balloon film by using the bordering material. Modifications to the assembly line described above can be made to yield different results. For instance, the two rolls of film need not be the same size. Instead, a first roll may have a first width, and a second roll may have a second width. In this case, the heat sealing machine can be positioned between the first roll and the second roll in order to seal the unrolled balloon films. The one or more rolls of balloon film need not be of the same thickness or material type. For example, a first roll may be of a balloon film of 0.3 mil PET and a second roll may be comprised of a balloon film of 0.5 mil Nylon. It is also possible to use 2 rolls of balloon film which already include the border on the edges, thus removing the need to add the border right before butt welding the two rolls of balloon film. Instead of rolling the sealed balloon film into a new spool, the new sealed balloon film can be cut off after a certain length. In yet another embodiment, more than two rolls may be arranged linearly, with the rolls aligned on the same plane and placed with their ends abutting. When unrolling the two or more rolls at the same time and same rate, the sealers seal the balloon films into a single balloon film.

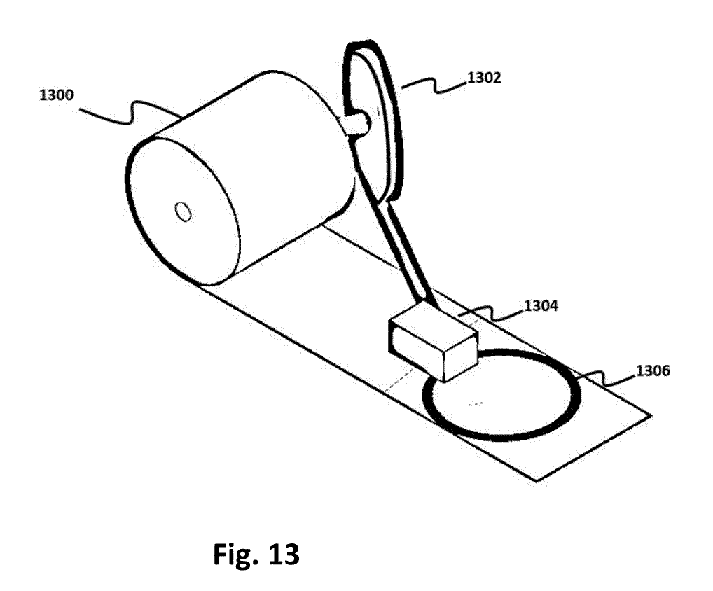

FIG. 13 shows an assembly for adding a circular border to a rectangular balloon film. The assembly includes roll of balloon film 1300 and a roll of border material 1302. As the balloon film and the border material are unrolled and preferably cut in particular lengths, a heat sealing machine 1304 seals the border material to the balloon film by moving on a circular track, or rotating the film segment on a circular table, among many other possibilities, resulting in the balloon film having a circular border 1306. The resulting balloon film with the circular border may then be cut and used as an end cap. In yet another embodiment, an impulse or RF curved bar welder may be used to seal the border on the balloon film. A cutting apparatus may also track along the circumference of the sealed border material to form the circular balloon film.

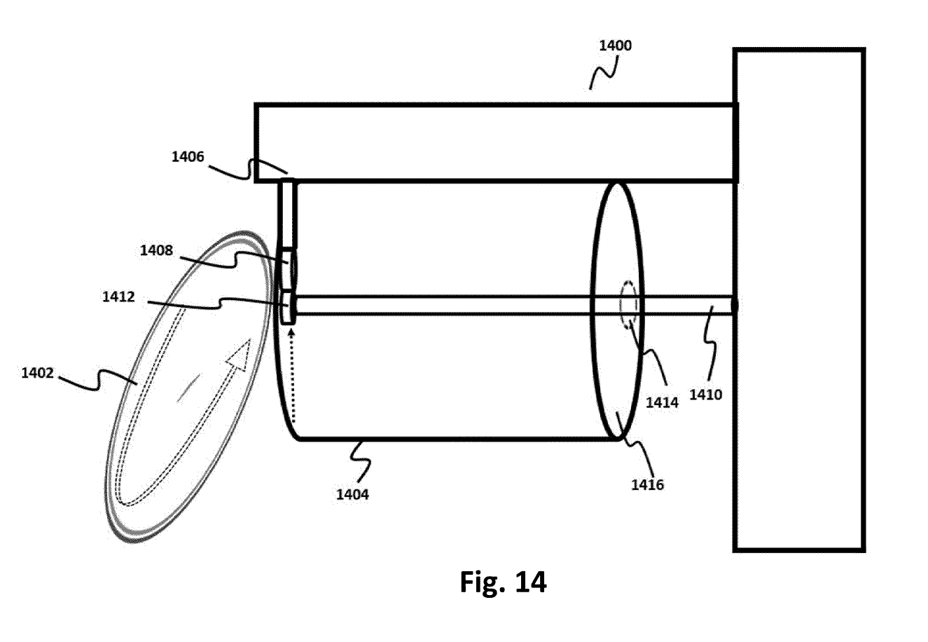

FIG. 14 is an embodiment of a sealing machine 1400 used to secure the end cap 1402 to the cylinder body 1404 in accordance with an embodiment. Many types of heat sealing machines may be used, such as RF, hot wheel, hot air, hot wedge, ultrasonic, laser, among others. The sealing machine 1400 includes a top arm 1406 which supports a top sealing wheel component 1408. A bottom arm 1410 includes a bottom wheel sealing component 1412 opposite the top wheel sealing component 1408. Depending upon the method of sealing chosen, the appropriate seal part configurations may change to incorporate a laser head, anvil and horn (ultrasonic welding), heat seal band, impulse or RF bar, among many other possible sealing parts and accessories. The cylinder body 1404 is threaded through the bottom arm 1410. The circumferential edge of the cylinder body 1404, including the border, is then fed between the top sealer 1408 and the bottom sealer 1412, keeping the circumferential edge of the circular end cap 1402 aligned with the circumferential edge of the cylinder body 1404. As the cylinder body 1404 turns, its circumferential edge is sealed to the circumferential edge of the circular end cap 1402, with one revolution completing the seal between the border of the end cap and the border of the cylinder body. An opening 1414 is made on the first end cap 1416 in order to pass the cylinder body 1404 through the bottom arm 1410.

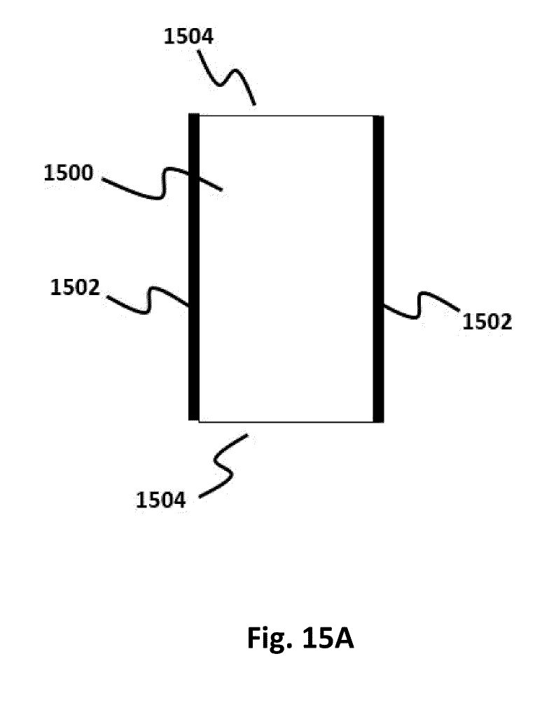

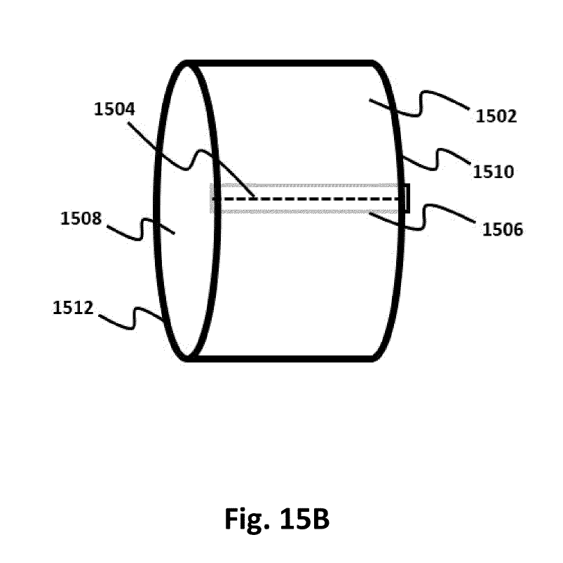

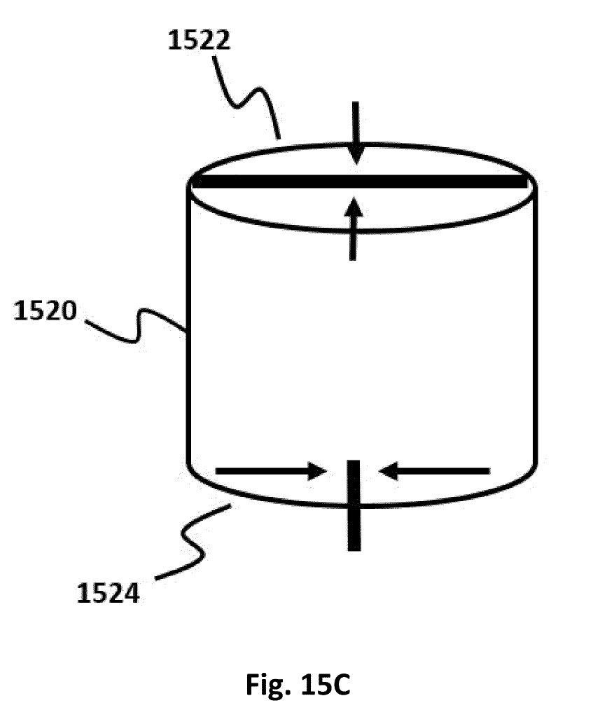

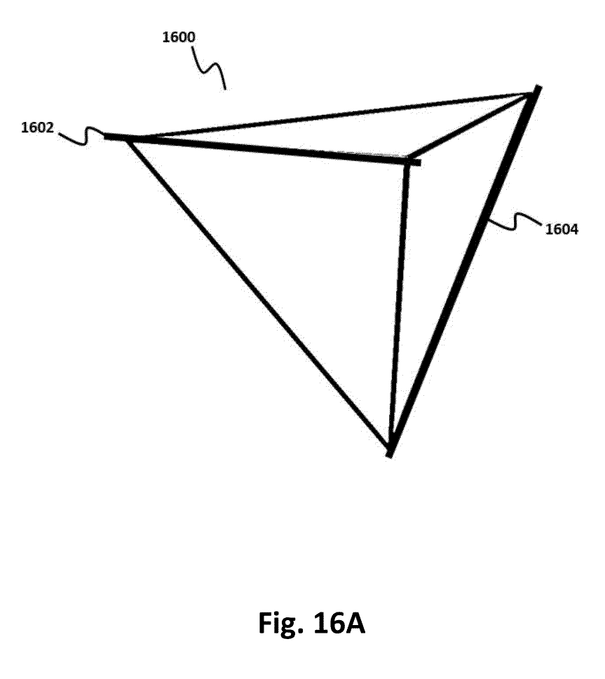

Though described above that a cylinder body with two circular end caps is more efficient in net lift and pressure resistance than a “pinched cylinder”, or pillow case balloon shape, there are several advantages of a pinched cylinder balloon shape including its ease of manufacture. FIG. 15 illustrates a balloon film 1500 including border material 1502 along its edges. The two shorter ends 1504 of the balloon film are joined together as illustrated in FIG. 15B, resulting on a cylindrical shape. The ends 1504 may be sealed together by butt welding the ends 1504, and applying a sealing border 1506. The resulting cylinder body includes two openings, a first open end 1508 (first circumferential edge) and a second open end 1510 (second circumferential edge). The bordered edge 1512 of the first open end 1508 is sealed along a vertical axis. The bordered edge of the second open end 1510 is sealed along a lateral axis, which is perpendicular to the vertical sealing direction of the first open end 1508. FIG. 15C illustrates a side view of a cylinder body 1520 with a first open end 1522, and a second open end 1524. The Figure illustrates the first open end 1522 being sealed along a first direction, while the second open end is sealed along a second direction that is perpendicular to the first direction.

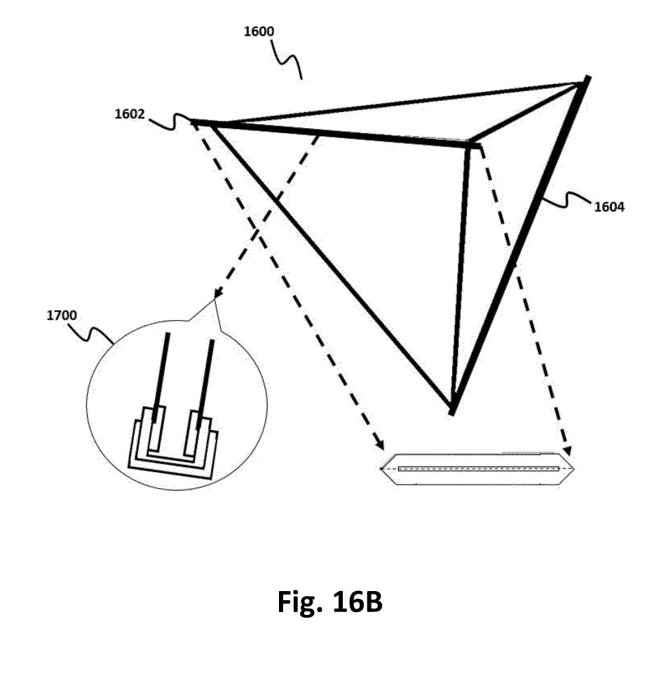

FIG. 16 illustrates a tetroon, or a substantially tetrahedron shaped, balloon 1600. The tetroon balloon 1600 is formed by using the sealing process from FIG. 15, where one open end of the cylinder body is sealed along a first direction, resulting in seam 1602, and a second open end of the cylinder body is sealed along a second direction which is perpendicular to the first direction, resulting in seam 1604.

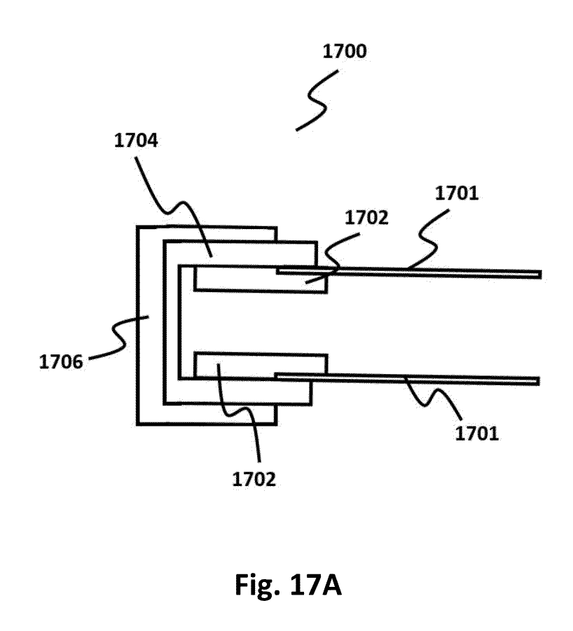

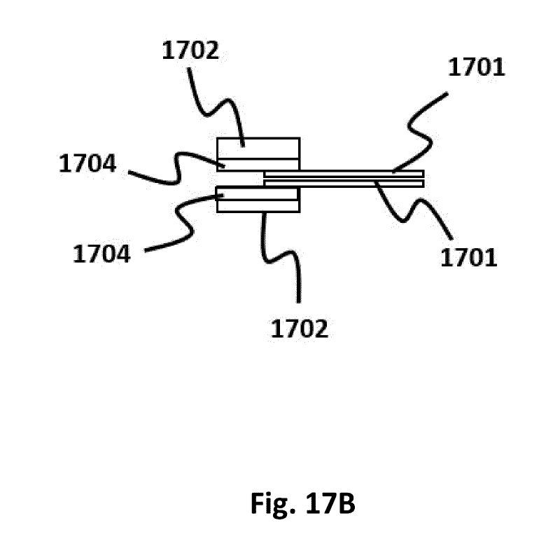

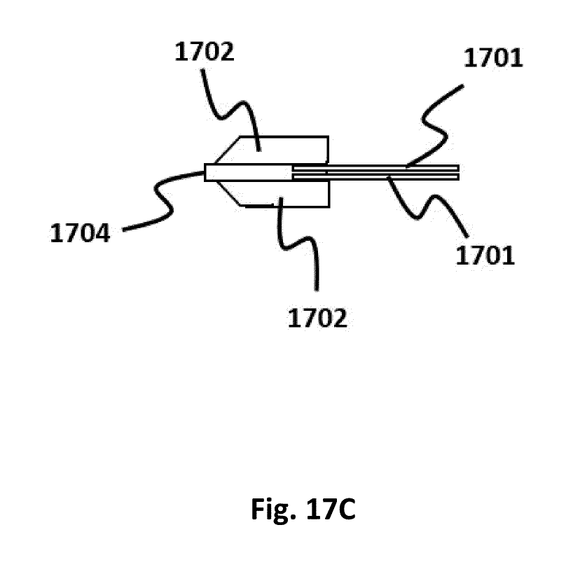

In yet another embodiment, the cylinder can be flipped inside out, with the heat sealable side facing outwards. A sealing strip can be wrap sealed over the previously bonded border, i.e. sandwiching the previously bonded border. Such a wrap seal provides a potential advantage over a pinch seal (fin seal) for higher pressure resistance as many materials have a higher pull tensile strength than peel tensile (or tongue tear) tensile strength, especially in the case of laminated fabrics and polymers. The sealing strip can also be pinch sealed at the corners at the point where it extends beyond the pinched cylinder seal. FIG. 17A illustrates a cross-sectional view of the wrap seal 1700 in accordance with an embodiment, where PET layer films 1701 have been sealed together with a fabric layer 1702 coated with a PU laminate layer 1704. The laminated fabric layer 1702 is on the inside because the cylinder has been flipped inside out, with the heat sealable PU layer side 1704 facing outwards. Sealing strip 1706, a laminate fabric also consisting of a PU laminate layer 1704 can be wrap sealed over the previously bonded border, i.e. sandwiching the previously bonded border. FIG. 17B and FIG. 17C illustrate a cross-sectional view of a fin seal (pinch seal) both before (17B) and after (17C) sealing

Traditionally tetroons and pinched cylinder balloons have weak points and/or gas leak paths at the four corners. Such balloons made from PE can obtain a perfectly hermetic seal, but are very weak at the corners as the thin PE material cannot withstand much pressure before stretching and tearing. Traditionally, such balloons made from PET cannot be directly sealed at the ends, and have relied upon adhesive tapes or heat-sealable tapes to bond along the length of the seam. This often creates small leak paths at the corners.

In present embodiments, the edges can be prepared with a strong, heat sealable border to create a cylinder. The edges can then be pinch sealed (lap sealed) for a strong airtight seal. Alternatively, another sealing strip can be wrap sealed over the edge to make the seam stronger for better pressure resistance. These embodiments can outperform previous tetroon designs made from PE, PET, and Nylon.

Yet another embodiment is directed to a high altitude balloon comprised of two parts: a first panel and a second panel. An embodiment of the high altitude balloon includes a substantially spherical body formed by two rounded-hourglass shape sheets of thin membrane material. The panels can be made of the same thin membrane material, or they may be made from a different material. The panels may have a substantially cupped (dished) shape or flat shape, though the panels may have different shapes. Load restraints may be used on the inside or outside of the balloon body either for reinforcement or to form a plurality of lobes on the balloon body.

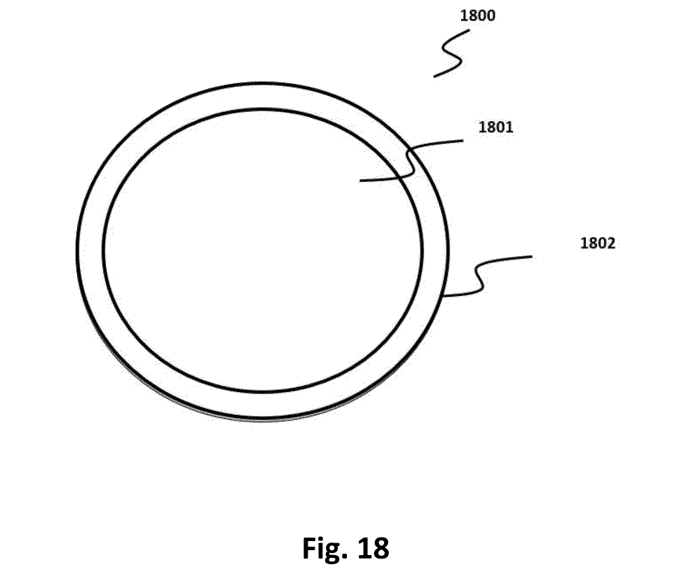

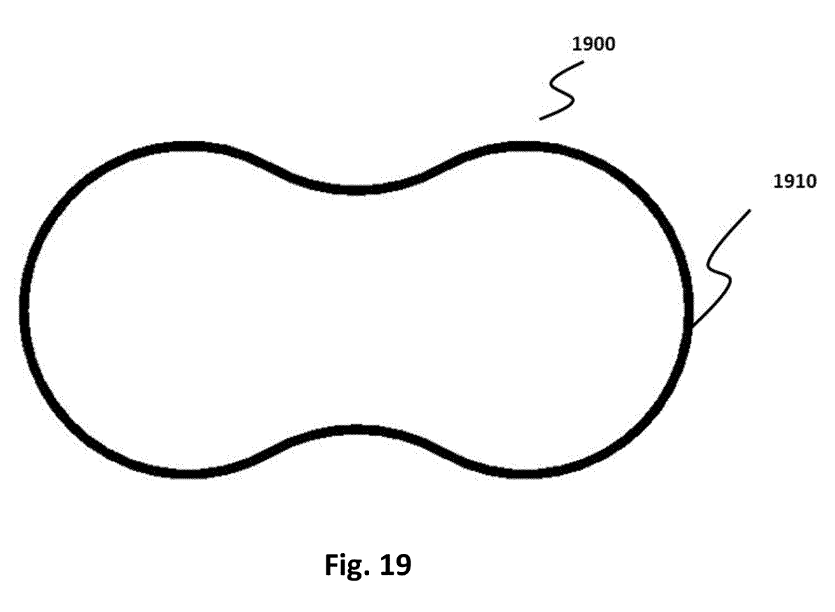

FIG. 18 illustrates the circular shape of the panels in the present embodiment. The circular balloon film 1801 has been bordered with a border 1802. FIG. 19 illustrates the rounded-hourglass shape of the panels in an embodiment. It should be noted that the first and second panels may be made (or spliced) from smaller sub-panels and/or sub-components attached to one another, and such modified designs would not depart from the spirit of embodiments described herein.

Embodiments may include one or more parts made from gores. For example, one embodiment of a balloon may consist of a first panel and a second panel, where none of these are made from gores. However, it is possible for one or more of these parts to be made from gores. For example, one balloon embodiment may be formed from a first panel without gores, and a second panel without gores. A second balloon embodiment may be formed from a first panel without gores, and a second panel made from gores. A third balloon embodiment may be formed from a first panel made from gores, and a second panel made from gores. Thus, it is possible to form balloon embodiments by combining one or more goreless pieces with one or more pieces made from gores. This is in contrast to prior balloons which are made entirely from gores.

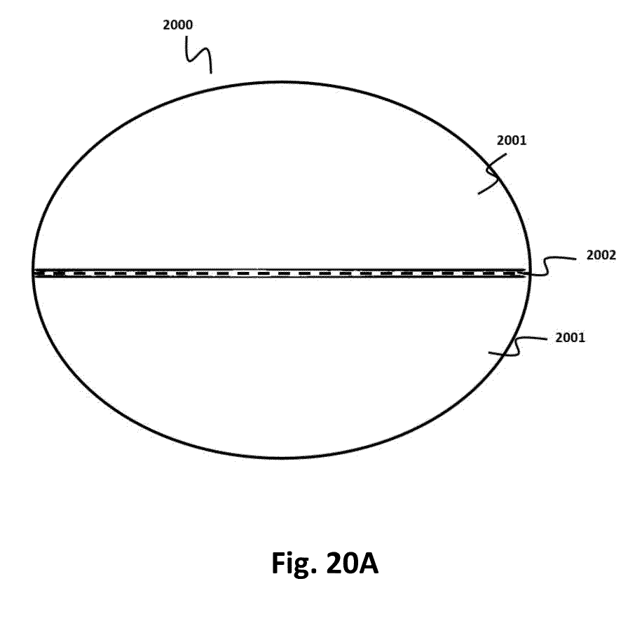

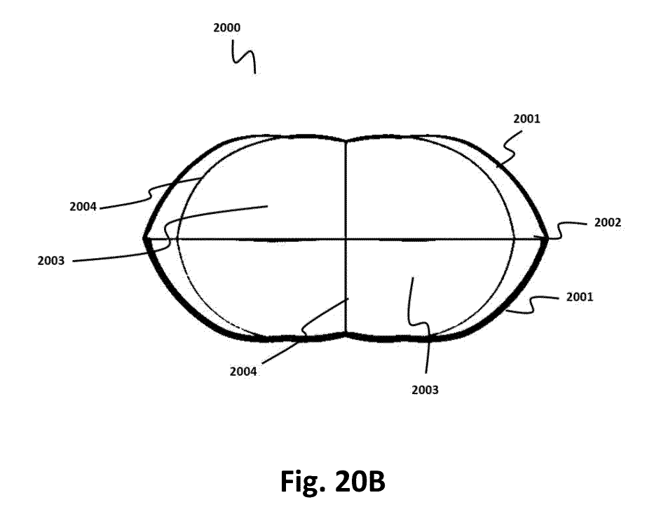

FIG. 20A illustrates an embodiment of a high altitude balloon. This embodiment illustrates a substantially spherical body 2000, formed from two (shown inflated) flat circular panels 2001, rather than being formed from a plurality of gores. Mesh and netting, multiple layers of balloon film, load and restraint lines, reinforcing strips, etc. can all be easily attached to each circular panel, inside or outside, before or after bonding each panel to one another. Different types of materials can be used for the top and bottom circular panels. This is in contract to current high altitude balloons that are comprised of full extending gores made from a single material that often require an additional “cap” be added to the top to help block UV radiation and withstand internal lift forces. Such “caps”, internal bladders, and any other needed additions and modifications will be much easier to process on flat panels rather than on a multitude of gores. The top panel can be made of a material (or coating) that blocks daytime radiation, and the bottom panel can be made of a material (or coating) that traps upward bouncing nighttime radiation in order to maintain a consistent internal balloon temperature. Thin films are not easily thermoformed because of their delicate nature. Such a flat panel balloon will allow the atmospheric pressure to naturally stretch and “form” two dished (hemispherical) shapes, combining to make a near sphere, while the balloon gains in altitude and internal pressure. Though the creases and wrinkles created by the expansion of the two flat panels will increase in size during the initial balloon inflation phase (think of a Mylar party balloon gathering wrinkles around its circumferential seam while inflating), these wrinkles can eventually disappear with enough pressure and balloon film expansion. However, FIG. 20B illustrates how such wrinkles help to form natural bulges 2003 that are preferable to reduce film stress by reducing the local radius of the film, particularly helpful if internal or external load lines and/or restraint lines 2004 can be incorporated to match the location where wrinkles will develop. The two panels may be attached to each other forming a single seam 2002 by continuously feeding and attaching the perimeters of the two panels side by side until the balloon shape is enclosed. However, in alternative embodiments the two panels may be joined by way of adding one or more joining seams around the panel edge. The joining seams may be made from coated fabric, rope, extrusion profiles, film, plastic, adhesive tape, connectors, fasteners, plastic zippers, barrier closures, or any other joining configuration.

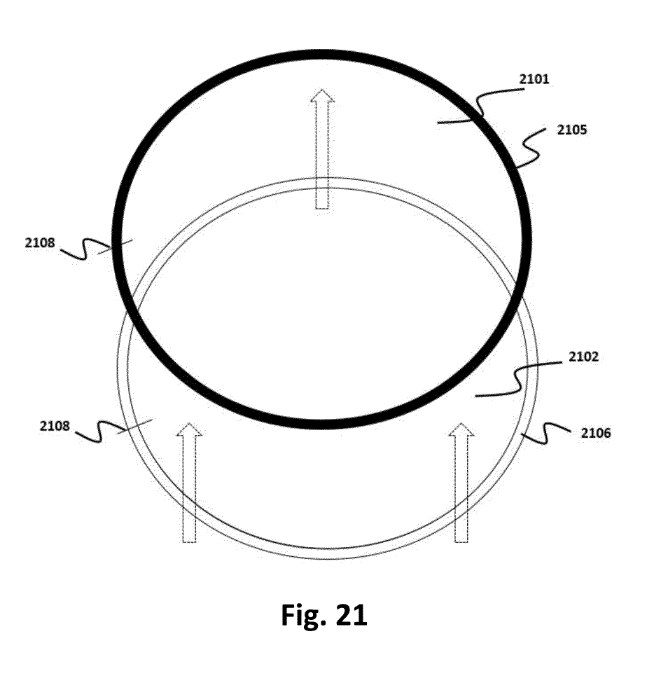

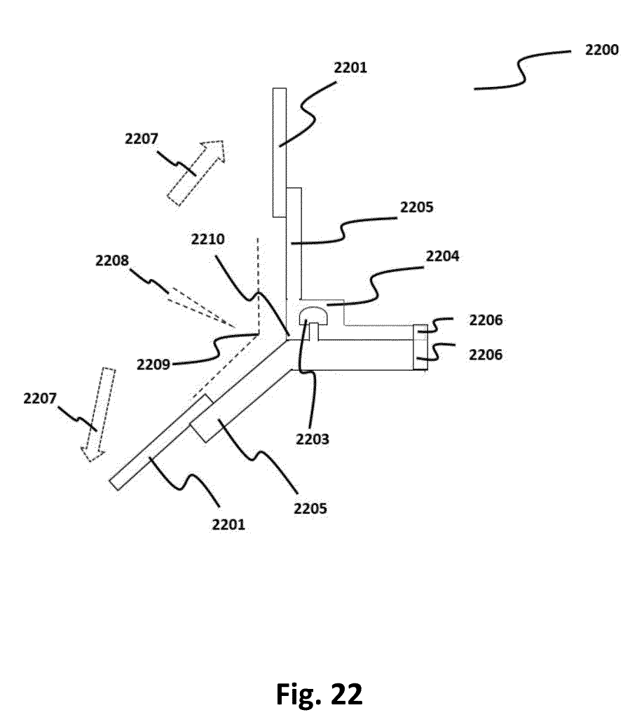

FIG. 21 shows one embodiment whereby a first panel 2101 with a male zipper bordering 2105 is attached to a second panel 2102 with a female zipper bordering 2106 to form a high altitude balloon. A zipper border termination weld and/or zipper coupling device may or may not be necessary depending upon whether the zipper bordering is dispensed from a continuous roll with ends 2108 or simply pre-fabricated into a continuous circle with no ends. A zippered high altitude balloon, or a high altitude balloon that links one or more balloon film panels with elements and channels (i.e. interlocking zipper teeth and/or teeth profiles and channels) among a multitude of other possible zipper designs, is very valuable toward enabling the mass production and reliability of such large inflatable structures. As many forms of zipper attachments can be bonded and mated on a flat 2-D dimension, this substantially reduces the need for material handling during high altitude balloon manufacture, further allowing precise and consistent quality control. Two flat panels bordered with a zipper bordering may be sealed together on a large table without moving the balloon film from its resting location. FIG. 22 demonstrates the advantages of a plastic zipper bordering 2200 for attaching together high altitude balloon panels 2201. As noted above, two high altitude balloon film panels can be bordered with plastic zipper strip bordering, and then they can be attached together by interlocking a male zipper profile 2105 with a female zipper profile 2106 to close the balloon.

FIG. 22 shows a cross sectional view of the mating of two balloon panels 2200 using male 2203 and female 2204 zipper profile borders. The balloon film panels 2201 may be bonded to the zipper profile flange 2205 before securing the bond of the male 2203 and female 2204 zipper profiles, though it is also possible to bond the balloon film panels to the zipper profile flanges during or after bonding the zipper profiles to one another. Though many zipper profiles exist that are hermetic (gas-tight) in nature, two upper zipper profile flanges 2206 may be sealed together to ensure that there is no potential gas leakage between the mated male 2003 and female 2204 profiles. When the top and bottom balloon panels 2201 bonded to the zipper profile flanges 2205 join together at the insertion of male profile 2203 into the female channel profile 2204, one panel lies directly on top of the other (flat 2-D balloon layout) with the zipper profile flanges 2205 nearly parallel as is shown with the acute angle 2208. When the high altitude balloon is either pressurized with gas or rises high enough into the atmosphere to be pressurized naturally, the zipper profile flanges begin to spread out along with the pressure force 2207 and separate from one another to form a growing obtuse angle 2209 between the two flanges. It is under this increasing tension that the joining point of the balloon seam 2210 would tend to overstretch or tear if the balloon was simply fin seal welded, for example. The high potential mechanical strength of zipper technology, however, allows for the secure anchoring of the zipper border mating joint 2210 and enables the balloon panels 2201 to pressurize and stretch toward their material tensile strength limits rather than first succumb to a much less robust peel (fin seal) strength failure. It is typical for current high altitude balloon panels to be fin sealed together, particularly those that are assembled on flat 2-D tables. Butt welds and lap welds may also help mitigate peeling force stresses at a typical seam joint intersection 2210, however, current manufacturing with these seam styles, as compared to zipper border technology, requires additional manual labor, customized equipment, 3-D material handling, and is difficult to replicate with exact precision while ensuring that no wrinkles are introduced to the seams.

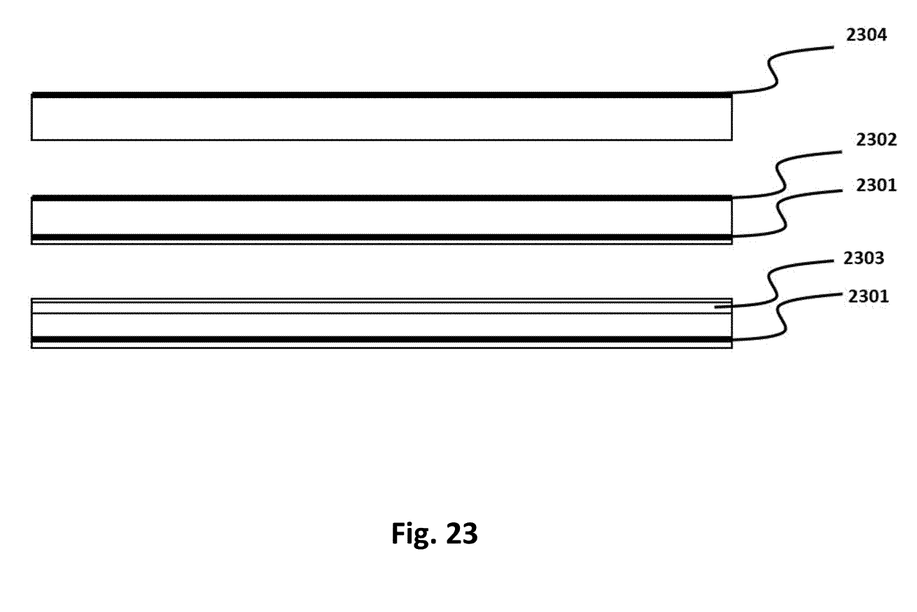

FIG. 23 shows examples of different types of zipper closure technology that may be used to create both a strong (mechanical) 2301 seal joint, a hermetic (gas-tight) seal joint (2302), a hermetic barrier heat seal 2303, a or both a strong (mechanical) and hermetic seal (2304) joint in one. Many different material compositions, sizes, gauges and configurations of zipper profiles, flanges, etc. are possible without departing from the spirit of the embodiments.

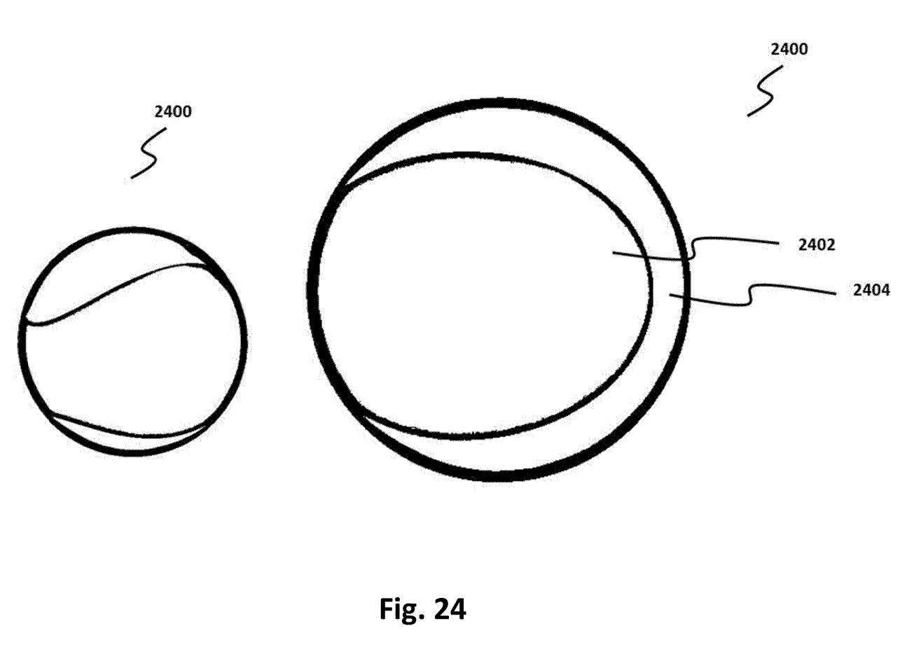

FIG. 24 also illustrates an embodiment of a high altitude balloon. This embodiment illustrates a substantially spherical body 2400, formed from two flat panels 1900, rather than being formed from a plurality of gores. The two panels may be attached to each other by attaching the wide section 2402 of the first panel to the narrow section 2404 of the second panel, forming a single seam by continuously feeding and attaching the perimeters of the two panels side by side until the balloon shape is enclosed. However, in alternative embodiments the two panels may be joined by way of adding one or more joining seams around the panel edge. The joining seams may be made from fabric, rope, film, plastic, adhesive tape, connectors, fasteners, zipper technology, or any other possible joining configuration.

The panels 1800 and/or 1900 include borders 1810 and/or 1910 attached around the edges of the flat panels. Such attachment methods of the two panels alone, or with additional joining seams, may be achieved by introducing adhesive, sewing, cementing, adhesive tapes, hot air and hot band welding techniques, hot wheel welding, laser welding, RF welding, ultrasonic welding, zipper technology, and/or a multitude of other securing techniques. The joining seam may be formed from the same material as the panel, or from an entirely different material.

As noted above, the membrane of the balloon may be made from polyethylene, polyester (Mylar), polyurethane, nylon, rubber, graphene, tightly knit and/or bonded fibers, multi-layer and co-extruded films, or any other suitable high altitude balloon membrane material. The membrane may be made from a single material layer or a combination of one or more other material layers.

In one embodiment, one or more internal bladders may be added to the inside of the balloon. Such one or more internal bladders can be used for lift gas containment, UV resistance, abrasion resistance, altitude control, among a host of other utilities. The internal bladders can be made of a myriad of different materials much like the outside balloon membrane.

In one embodiment load lines may be introduced to the balloon design either by securing to the flat panels or by incorporating into the joining seam, or by any other method. An alternative embodiment can incorporate the load lines into the membrane material itself. Load lines as used herein refer to lines on the outside of the balloon body which are used to support a payload.

As noted above in reference to other embodiments, the load lines may have a length equal to or greater than the length of the balloon. Regardless of the length of the load lines, the load lines may be made from any high-strength material. For example, polyester twine, polyester film strips, synthetic fiber, a KEVLAR line, spider silk thread, carbon nanotube thread, graphene strips, among other materials, may be used for the load lines.

The load lines may also be made to stretch or not stretch. If the load lines stretch, they can help absorb different types of pressure differentials and/or violent pressure shocks. Load lines that allow for violent and quick impact softening would stand up well to harsh wind gusts and sharp changes in wind directions, yet may halt stretching altogether once reaching a particular stretch limit.

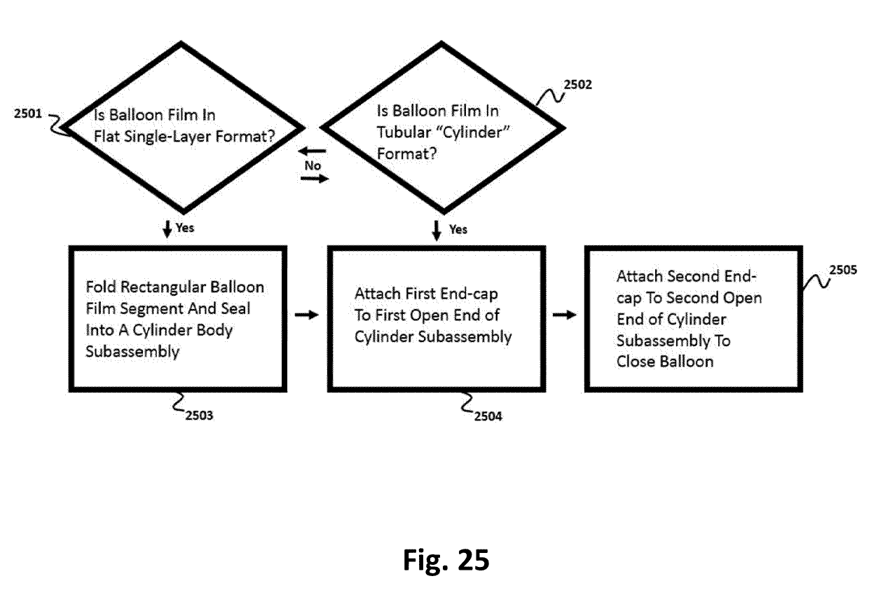

FIG. 25 illustrates a flowchart for building a substantially cylindrical shaped high altitude balloon in accordance with embodiments. In step 2501 we determine if the balloon film is in a flat format, i.e. die-cast in a single layer or slit from a tubular format to become a single wall layer. If we determine that the balloon film is in a flat format (Yes), then in step 2503 we may take a substantially rectangular piece of the balloon film and fold it into a substantially cylindrical shape. By sealing together the two shorter ends of the rectangular piece, we will now have a balloon cylinder body subassembly. If in step 2501 we determine that the balloon film is not in a flat format (No) then we move on to step 2502. In step 2502 we determine if the balloon film is in a tubular “cylinder” format such as a layflat tube produced by plastic blow extrusion, among other possible methods. If the balloon film is already in a tubular format, then we may move directly to step 2504. In step 2504 we begin to close up the high altitude balloon by attaching a first end-cap to a first open end of the cylinder body subassembly. In order to close up the balloon, we may move to step 2505 by attaching a second end-cap to a second open end of the cylinder body subassembly. It should be noted that a variety of differently sized and shaped balloon film sections may be attached together to make up the cylinder body and cylinder end-cap subassemblies in order to give them their required size and strength for any given balloon configuration. For example, 1 or more flat rectangular pieces of balloon film may be bonded together from a narrower web of balloon film in order to successfully complete a larger cylinder body otherwise not possible to create from a single narrow web of balloon film. The same is possible with the creation of the balloon end-cap sub-assemblies.

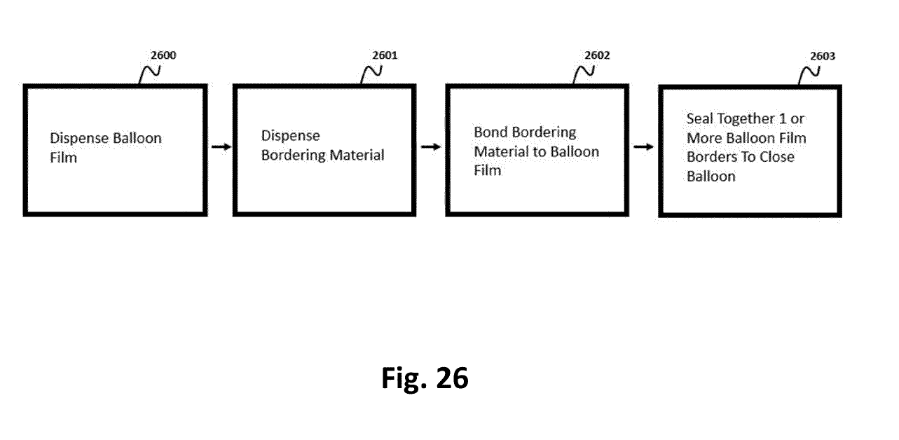

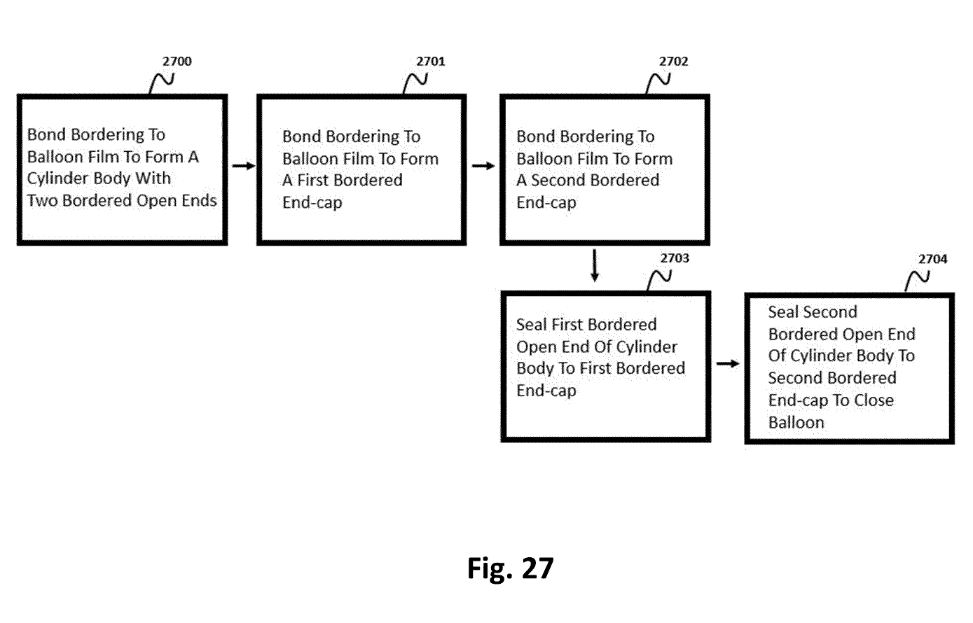

FIG. 26 illustrates a flowchart for building a variety of differently shaped high altitude balloons by bordering the balloon film in accordance with embodiments. In step 2600 we dispense balloon film from a continuous roll or other film storage format. The balloon film may also be dispensed directly off of an extrusion line or any other manufacturing process that creates balloon film. In step 2601 we dispense 1 or more bordering materials which will be used as balloon joining seams. It should be noted that many balloon films are thin and delicate in nature, and/or may be difficult to heat seal and retaining strength at a seam joint, and thus a bordering material added to the film may greatly improve the balloon's sealing ability and seam strength capabilities, particularly when under substantial pressure. In step 2602 we bond the bordering material to the balloon film in any host of possible configurations. We may create continuous rolls of film with bordered edges, create circular end-caps with bordered edges, and may create any other shape or design required for one or more bordered high altitude balloon sub-assemblies. Bonding and securing methods may include heat sealing, adhesive, mechanical, or any other bonding method. In step 2603 we close up the balloon by bonding together one of more of the bordered edges of the balloon sub-assemblies. For example, FIG. 27 steps 2700-2704 illustrate a flowchart to create a substantially cylindrical shaped high altitude balloon by bonding first and second bordered end-cap sub-assemblies to the first and second bordered open ends of a cylinder subassembly in accordance with embodiments. A single bordered cylinder subassembly may also be closed into a high altitude balloon with no need for further subassemblies (tetrahedron or pillow-case balloon) by simply pinch bonding down or wrap sealing the bordered cylinder open ends, i.e. flattening the cylinder open end into half of its circumference.

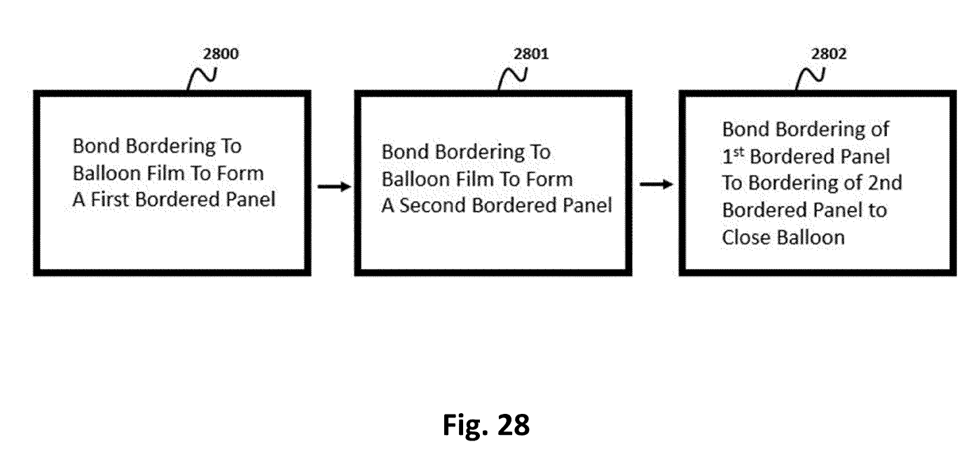

FIG. 28, steps 2800-2802 illustrate a flowchart to create a high altitude balloon from two bordered panels (i.e. circles and hourglass shapes for example) bonded to one another in accordance with embodiments. Any other host of balloon panel sizes, shapes and configurations are possible to create by bordering one or more sub-assemblies and bonding bordered edges together to create a high altitude balloon.

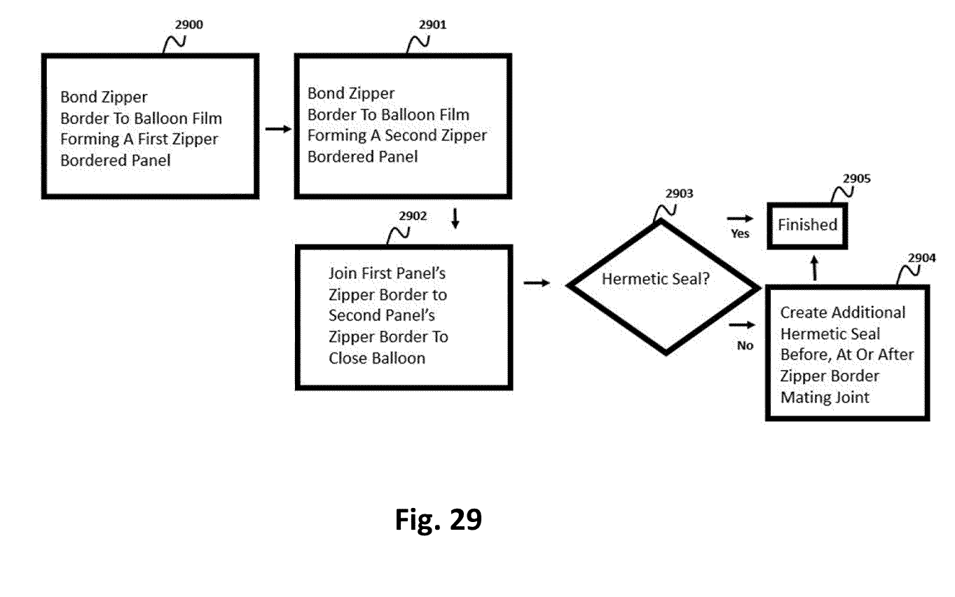

FIG. 29, steps 2900-2903 illustrate a flowchart to create a high altitude balloon from two panels (i.e. circles and hourglass shapes for example) bordered with one or more zipper borders to mechanically and hermetically close a high altitude balloon in accordance with embodiments. In step 2903 we verify whether or not the high altitude balloon is hermetically sealed with the zipper bordering closure. If “NO” step 2904, then we must create a hermetic seal either before, with or after the zipper profile closure by heat sealing together the upper zipper flanges, sealing all or a portion of the mating profiles together, adding a barrier zipper profile, using additional barrier methods including but not limited to FIG. 23, and/or using any other methods necessary to successfully create a hermetic seal.

Yet another embodiment is directed to a high altitude balloon, comprising a first chamber having a substantially cylindrical shape, the first chamber having a first circumferential edge and a second circumferential edge; a first end cap coupled along the first circumferential edge; and a second end cap coupled along the second circumferential edge.

Yet another embodiment is directed to a high altitude balloon, comprising a first panel having a substantially hourglass shape, the first panel having a first border sealed along an edge of the first panel; a second panel having a substantially hourglass shape, the second panel having a second border sealed along an edge of the second panel; wherein the first panel is coupled to the second panel by sealing the first border to the second border.

Yet another embodiment is directed to a high altitude balloon, comprising a first panel having a substantially circular shape, the first panel having a first border sealed along a circumferential edge of the first panel; a second panel having a substantially circular shape, the second panel having a second border sealed along a circumferential edge of the second panel; wherein the first panel is coupled to the second panel by a seal between the first border and the second border.

While embodiments have been illustrated and described herein in terms of several alternatives, it is to be understood that the techniques described herein can have a multitude of additional uses and applications. Accordingly, embodiments should not be limited to just the particular description, embodiments, and various figures contained in this specification that merely illustrate various embodiments. Finally, the various steps from the various alternative embodiments may be combined without departing from the spirit of embodiments described herein.

What is claimed is:

1. A high altitude balloon, comprising:
a first chamber having a substantially cylindrical shape, the first chamber having a first circumferential edge and a second circumferential edge;
a first end cap coupled along the first circumferential edge; and
a second end cap coupled along the second circumferential edge.

2. The high altitude balloon of claim 1, wherein the first chamber is formed from one rectangular film without gores.

3. The high altitude balloon of claim 2, wherein the first end cap is formed from a first circular film without gores, and wherein the second end cap is formed from a second circular film without gores.

4. The high altitude balloon of claim 1, wherein the first end cap and the second end cap are formed from substantially rectangular shaped films.

5. The high altitude balloon of claim 1, further comprising one or more inner restraint lines secured along an inner surface of the first chamber.

6. The high altitude balloon of claim 5, wherein the one or more inner restraint lines are arranged along a circumference of the inner surface of the first chamber.

7. The high altitude balloon of claim 1, further comprising one or more outer restraint lines secured to an outer surface of the first chamber.

8. The high altitude balloon of claim 1, further comprising one or more load lines secured to an outer surface of the first chamber, the first end cap, and the second end cap.

9. The high altitude balloon of claim 1, wherein the first circumferential edge includes a first border, wherein the first end cap includes a second border, wherein the second circumferential edge includes a third border, wherein the second end cap includes a fourth border, wherein the first end cap is coupled to the first circumferential edge by sealing the first border to the second border, and wherein the second end cap is coupled to the first circumferential edge by sealing the third border to the second border.

10. The high altitude balloon of claim 9, wherein the first border, the second border, the third border, and the fourth border are made from a heat sealable substrate.

11. The high altitude balloon of claim 9, wherein the first border, the second border, the third border, and the fourth border are comprised of a zipper bordering.

12. The high altitude balloon of claim 1, wherein the first circumferential edge includes a first border, wherein a portion of the first border extends beyond the first circumferential edge, wherein the second circumferential edge includes a second border, wherein a portion of the second border extends beyond the second circumferential edge, wherein the first end cap is coupled to the first circumferential edge by sealing a circumferential edge of the first end cap to the portion of the first border that extends beyond the first circumferential edge, wherein the second end cap is coupled to the second circumferential edge by sealing a circumferential edge of the second end cap to the portion of the second border that extends beyond the second circumferential edge.

13. The high altitude balloon of claim 12, wherein the first border and the second border are made from a heat sealable substrate.

14. The high altitude balloon of claim 12, wherein the first border and the second border are comprised of a zipper bordering.

15. A high altitude balloon, comprising:
a first panel having a substantially hourglass shape, the first panel having a first border sealed along an edge of the first panel;
a second panel having a substantially hourglass shape, the second panel having a second border sealed along an edge of the second panel;
wherein the first panel is coupled to the second panel by sealing the first border to the second border.

16. The high altitude balloon of claim 15, wherein a waist of the substantially hourglass shape of the first panel is adjacent to an apex of the substantially hourglass shape of the second panel.

17. The high altitude balloon of claim 15, wherein the first border and the second border are made from a heat sealable substrate.

18. The high altitude balloon of claim 15, wherein the first border and the second border are comprised of a zipper border.

19. A high altitude balloon, comprising:
a first panel having a substantially circular shape, the first panel having a first border sealed along a circumferential edge of the first panel;
a second panel having a substantially circular shape, the second panel having a second border sealed along a circumferential edge of the second panel;
wherein the first panel is coupled to the second panel by a seal between the first border and the second border.

20. The high altitude balloon of claim 19, wherein the first border and the second border are made from a heat sealable substrate.

21. The high altitude balloon of claim 19, wherein the first border and the second border are comprised of a zipper border.

22. The high altitude balloon of claim 19, wherein the first panel is formed from one film without gores, and wherein the second panel is formed from one film without gores.

23. The high altitude balloon of claim 19, further comprising one or more inner restraint lines secured to an inner surface of the first panel and the second panel.

24. The high altitude balloon of claim 19, further comprising one or more outer restraint lines secured to an outer surface of the first panel and the second panel.

25. The high altitude balloon of claim 19, further comprising one or more load lines secured to an outer surface of the first panel and the second panel.
